(19) United States
(12) Patent Application Publication
(10) Pub. No.: US 2009/0238479 A1
(43) Pub. Date: Sep. 24, 2009

(54) Flexible frame based energy efficient multimedia processor architecture and method

(76) Inventors: Pawan Jaggi, Plano, TX (US); Sandeep Kumar, Austin, TX (US); Xiaohui Wei, Richardson, TX (US)

Correspondence Address: George R. Schultz;Schultz & Associates, P.C., One Lincoln Centre, 5400 LBJ Freeway, Suite 1200, Dallas, TX, 75240, US

(21) Appl. No.: 12/322,720

(22) Filed: Feb. 6, 2009

Related U.S. Application Data
(60) Provisional application No. 61/070,213, filed on Mar. 20, 2008.

(51) Int. Cl. G06K 9/46; G06K 9/36

(52) U.S. Cl. 382/236; 382/246

(57) ABSTRACT

A codec system is provided which includes encoding and decoding functions in a plurality of application environments. The codec subsystem encodes raw uncompressed HD-SDI video signals from a camera's optical subsystem into an MPEG-2 transport stream which is stored in onboard media. The subsystem may be programmed to encode or decode a plurality of video and audio formats as required by multiple HD-camera manufactures. A stand alone encoder decoder system is also provided in a network configuration for a studio production system. A programmable set of hardware including BSP, HD-SDI, SD-SDI, multiplexer/demultiplexer and MPEG-2 transport streams are provided. An intelligent power consumption management system is also provided.

### CROSS-REFERENCE TO RELATED APPLICATIONS

This application claims priority to U.S. Provisional Application No. 61/070,213 filed Mar. 20, 2008.

### TECHNICAL FIELD OF THE INVENTION

This invention relates to a system and methods for encoding and decoding video signals or files from a video transport stream or raw video data file, respectively, into a constant bit rate (CBR) high level MPEG-2 ISO/IEC compliant transport stream wherein the CBR is maintained for each processed frame in a video sequence.

### BACKGROUND OF THE INVENTION

The challenges created by the ever evolving video encoding and transport standards force new generations of video equipment that customers have to manage, control and continue to invest in. Expensive equipment purchased by video product manufacturers such as a professional HD camera manufacturer has to be removed and replaced by equipment built for new standards. To manage in this environment advanced but economical video compression techniques are required to store or transmit video. Furthermore, a dynamic platform is required to accommodate the ever evolving standards in order to reduce equipment churn.

Conventional approaches require complex ASICS or arrays of DSPs to manage the intensive signal processing which reduces flexibility, comprises quality and adds non-recurring engineering costs inherent in ASIC production. What is needed is high performance, high speed, low cost high speed hardware platform in combination with software programmability so that future video signal processing standards may be incorporated into the platform as those standards evolve.

A state of art constant bit rate (CBR) encoder provides average constant bits over time. The MPEG-2 encoder of the present invention compresses every input frame with MPEG-2 intra coding with group of picture (GOP) size equal to 1 (one). The present invention provides not only average constant bits over time, but an exactly same number of output bits for each frame. The output bitstream compressed by the MPEG-2 encoder can easily accept inserted, deleted or replaced content of a given frame at any position in the bitstream without uncompressing the whole bitstream, the modified bitstream remaining MPEG-2 compliant. A strict frame CBR compliant MPEG-2 encoder has wide applicability in professional video program editing or digital Television standard, for instance, in manipulating D-10 bit streams as described in SMPTE 356M-2001, “SMPTE Standard for Television—Type D-10 Stream Specifications—MPEG-2 4:2:2P@ML for 525/60 and 625/50”, Aug. 23, 2001.

U.S. Pat. No. 7,317,839 entitled “Chroma Motion Vector Derivation for Interlaced Forward-Predicted Fields” to Holcomb discloses a digital video bitstream producing method for computer by outputting encoded video data & controls to control post-processing filtering video data after decoding.

U.S. Patent Publication No. 2002/0041632 entitled “Picture Decoding Method and Apparatus” to Sato, et al. discloses an MPEG decoder for digital television broadcasting that has activity compensation for reverse orthogonal transformation image based on reference image.

U.S. Pat. No. 6,434,196 entitled “Method and Apparatus for Encoding Video Information” to Sethuraman, et al. discloses a video information encoding system for communication and compression system that employs Micro-block sectioning.

U.S. Pat. No. 5,973,740 entitled “Multi-Format Reduced Memory Video Decoder with Adjustable Polyphase Expansion Filter” to Hrusecky discloses expanding decimated macroblock data in digital video decoding system with coding for both field and frame structured coding.

The present invention addresses the need for a programmable video signal processor through a combination of a hardware and dynamic software platform for video compression and image processing suitable for broadcast level high definition (HD) video encoding, decoding and imaging. The dynamic software platform is implemented on a low cost multicore DSP.

### SUMMARY OF INVENTION

The present invention is a programmable energy efficient codec system with sufficient flexibility to provide encoding and decoding functions in a plurality of application environments.

In one application of the present invention, a camera control system for an HD-Camera is envisioned wherein a first embodiment hosted codec subsystem encodes raw uncompressed HD-SDI video signals from the camera's optical subsystem into an MPEG-2 transport stream. A host system in the HD-camera stores the MPEG-2 transport stream on storage media onboard the HD-camera. The host system also exchanges status and control with the first embodiment codec subsystem. Raw uncompressed audio and video files may be passed through the codec susbsystem and stored by host system for subsequent processing. The codec susbsystem may be programmed to encode or decode a plurality of video and audio format as required by multiple HD-camera manufacturers.

In a second application of the present invention, a stand alone encoder system and stand alone decoder system is assembled into a network configuration suitable for studio production system allowing for remote display and editing of HD-SDI video. The stand alone encoder and decoder utilize a second embodiment codec subsystem. At least one of a plurality of HD-SDI transport streams generated from a plurality of HD-cameras is encoded into an MPEG-2 transport stream which is output by the stand alone encoder into a DVB-ASI signal and a TS over IP packet stream, the latter being suitable for MPEG-2 transport over a routed IP network. The stand alone decoder accepts MPEG-2 TS over IP packet streams from a routed IP network and decodes them into uncompressed HD-SDI transport stream useful for display. The MPEG-2 transport stream arriving at the stand alone decoder may be generated by a stand alone encoder on site to the studio production. A local workstation may accept DVB-ASI signals from the encoder for local video editing and storage. A remote workstation may accept TS/IP MPEG-2 files for remote video editing and storage. The codec susbsystem may be programmed to encode or decode a plurality of video and audio format as required by multiple studio production houses.

The embodiments described have hardware systems based on a field programmable set of hardware including a DSP, a HD-SDI and SD-SDI multiplexer/demultiplexer, an MPEG-2 compatible transport stream multiplexer/demultiplexer, a boot controller, and a set of external interface controllers. In one embodiment of the codec system, the set of external interface controllers includes a PCI controller for a PCI bus interface. In a second embodiment codec system, the set of external interface controllers includes a panel interface controller for accepting input from a keypad, displaying output on a LCD display screen and communicating alarm information through a digital interface.

The software framework of the many embodiments of the present invention has the capability to intelligently manage system power consumption through a systems energy efficiency manager (SEEM) kernel which is programmed to interact with various software modules, including modules that can adaptively control system voltage. The SEEM kernel monitors required speed and required system voltage while in different operational modes to ensure that required speed and voltage are maintained at minimum necessary levels to accomplish required operations. The SEEM kernel enables dramatic power reduction over and above efficient power designs chosen in the hardware systems architecture level, algorithmic level, chip architecture level, transistor level and silicon level optimizations.

To accommodate the SEEM kernel and to allow for ease of system update and upgrade, and ease of development of a variety of different systems or encoder/decoder algorithms, the DSP based software framework utilizes a dual operating system environment to run system level operations on a system OS and to run computational encoder/decoder level operations on a DSP OS. A system scheduler manages the operations between the two OS environments. A set of system library interfaces are utilized for external interface functions and communications to peripherals allowing for a set of standard APIs to be available to host systems when the codec is in a hosted environment. A set of DSP library interfaces allow for novel DSP intensive encoder functions relating to operations such as discrete cosine transformations, motion estimation, quantization matrix manipulations, variable length encoding functions and other compression functions.

In another aspect of the invention, algorithms used for encoding in the codec system include at least the function of performing discrete cosine transforms (DCT), the function of applying a quantization matrix (Q) to the DCT signal, the function of applying a variable length encoding (VLC) to the quantized signal, and formatting the output signal into an elementary transport stream (TS).

A constant bit stream is accomplished through a rate control function to adjust quantization matrix scale factors on-the-fly and per image slice. The DCT function includes the ability to perform a prediction of quantization parameters which are fed forward to rate control function. Improvements in the encoding function and rate control function in general may be made over time and incorporated through program updates via the flash memory.

These and other inventive aspects will be described in the detailed description below.

### BRIEF DESCRIPTION OF DRAWINGS

The disclosed inventions will be described with reference to the accompanying drawings, which describe important sample embodiments of the invention and which are incorporated in the specification hereof by reference, wherein:

FIGS. 1a and 1b are schematic diagrams of a HD-Camera codec system application in the first embodiment.

FIG. 2 is a schematic diagram of stand alone codec system application for a studio quality video production environment in the second embodiment.

FIG. 3 is block diagram of the hardware functionality of the first embodiment codec system.

FIG. 4 is a block diagram showing the energy efficient multimedia processing platform.

FIG. 5 is block diagram showing the detailed software architecture including data and control flow of the codec system.

FIG. 6 is a state diagram indicating the states of the codec software system.

FIG. 7 is a block diagram showing an overview of the recording function of the first embodiment codec system.

FIG. 8 is a block diagram showing an overview of the playback function of the first embodiment codec system.

FIG. 9 is block diagram of the hardware functionality of the second embodiment codec system.

FIG. 10 shows a front and rear perspective of an encoder box in the second embodiment.

FIG. 11 shows a front and rear perspective of a decoder box in the second embodiment.

FIG. 12 is block diagrammatic view of the construction of frame subblocks for frame based encoding and decoding.

FIG. 13 is a table of preferred encoder modes of the codec system.

FIG. 14 is a block diagram of a MPEG-2 record video packet format.

FIG. 15 is a table showing the detail of the MPEG-2 record video packet format.

FIG. 16 is a set of tables showing the host software API commands, encoder revisions information, and operating modes.

FIG. 17 is a table showing the host software API encoder control functions.

FIG. 18 is a table showing the host software API encoder video source control options.

FIG. 19 is a block diagram showing the primary functions of the system energy efficiency manager kernel.

FIG. 20 is a block diagram of the components of the system energy efficiency manager kernel.

FIG. 21 is a block diagram of the encoding functions of the encoder.

FIG. 22 is a flow diagram of a first embodiment rate control process.

FIG. 23 is a flow diagram of a second embodiment rate control process.

FIG. 24 is a flow diagram of a rate controlled encoder process.

### DETAILED DESCRIPTION

The flexible video processor of the present invention may be implemented in a variety of embodiments in different application environments incorporating hardware platforms suitable to the environment. Two relevant application environments including high definition camera hardware, high definition video production are described along with corresponding embodiments of the flexible video processor. Many other applications and embodiments of the present invention may be conceived so that the inventive ideas disclosed in relation to the given applications are not to be construed as limiting the invention.

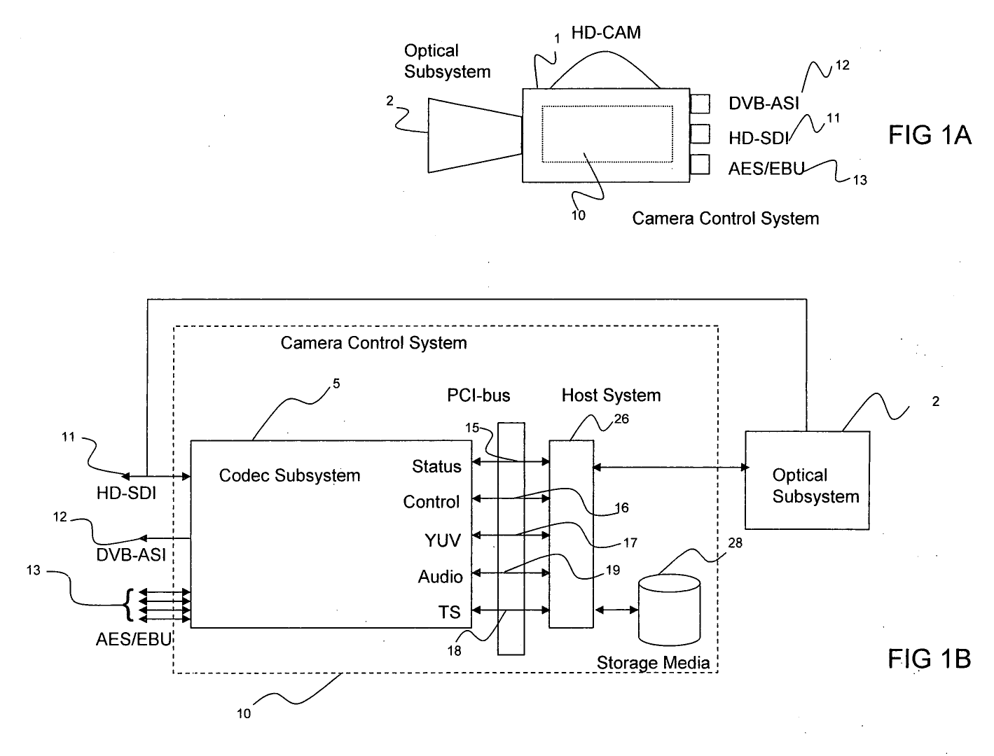

A first application of the present invention is in a high definition video production camera as shown in FIGS. 1A and 1B. In FIG. 1A, HD camera 1 comprises optical subsystem 2 and camera control system 10 and has external interfaces of at least one DVB-ASI interface 12, a set of AES/EBU standard audio channel interfaces 13 and a HD-SDI interface 11. Other controls not shown may exist on the HD camera to control its optical and electronic functions. The camera control system 10 is depicted in FIG. 1B comprising codec subsystem 5 and host subsystem 26 with storage media 28 attached thereto. Codec subsystem 5 and host subsystem 26 exchange data via PCI bus interface 27. Under control of host system 26, optical subsystem 2 functions to focus and control light, sense light, digitize and stream uncompressed HD-SDI signal 8 according to the SMPTE 292M standard. Codec subsystem 5, which is the object of the present invention, functions to encode HD-SDI signal 8 recording compressed audio/video files 18 onto storage media 28 via PCI bus interface 27 and host subsystem 26. Stored compressed audio/video files 18 from host subsystem 26 may also be decoded and played back through codec subsystem 5. Audio encoded in stored compressed audio/video files 18 may be played back through the AES/EBU port 13 which is typically a 4 channel 8 wire interface.

Codec susbsystem 5 interfaces to host subsystem 26 through PCI bus 27 to allow for control signals 44 and status signals 45 to flow between the two subsystems. In the encoder mode of operation, the input video/audio stream for codec subsystem 5 is demultiplexed and encoded from uncompressed HD-SDI signal 8. A MPEG-2 transport stream (TS) encoded by codec subsystem 5 is sent to DVB-ASI interface 12 and also forms compressed audio/video files 18 with record headers documenting format information and content metadata if required.

Uncompressed HD-SDI signal 8 may also be demultiplexed and stored as raw YUV video data files 17 and raw audio data files 19 in storage memory 28. Uncompressed raw data files allow for future editing and processing without loss of information that occurs during the encoding and compression processes. Codec subsystem 5 may playback raw video and audio data files to the HD-SDI interface 11 and AES/EBU port 13, respectively.

Codec subsystem 5 is implemented on a digital signal processor and may be programmed to support a variety of encoding, decoding and compression algorithms.

The HD camera application illustrates an example of a first embodiment of the present invention that utilizes a codec system, host system and PCI bus between the two systems to perform video encoding and decoding operations. The host system need not be embedded as in the HD-camera 1, but may be a computer system wherein the codec subsystem may be a physical PCI card connected to the computer. Novel encoding and decoding operations of the present invention will be described in greater detail. A commercial example of the first embodiment codec system is the HCE1601 from Ambrado, Inc.

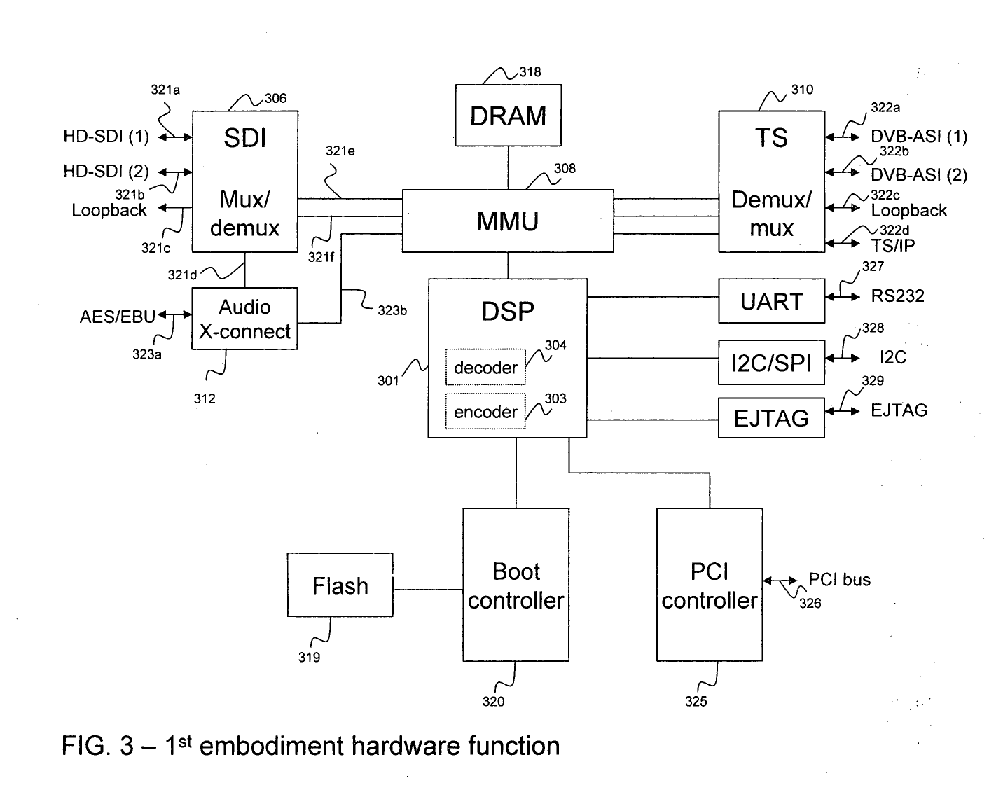

Moving to the block diagram of FIG. 3, codec system 300 of the first embodiment of the present invention comprises a DSP microprocessor 301 to which memory management unit MMU 308, a SDI mux/demux 306, a transport stream (TS) mux/demux 310 and an audio crossconnect 312 are attached for processing video and audio data streams. DSP microprocessor 301 implements video/audio encoder functions 304 and video/audio decoder functions 303. DSP microprocessor 301 has interfaces RS232 PHY interface 327 for external control interface, I2C and SPI load speed serial interfaces for peripheral interfacing, EJTAG interface 329 for hardware debugging and a PCI controller 325 for controlling a PCI bus interface 326 to a host system. Boot controller 320 is included to provide automatic bootup of the hardware system, boot controller 320 being connected to flash memory 319 which holds program boot code, encoder functional code and decoder functional code which may be executed DSP microprocessor 301.

DSP microprocessor 301 is a physical integrated circuit with CPU, I/O and digital signal processing hardware onboard. A suitable component for DSP microprocessor 301 having sufficient processing power to successfully implement the embodiments of the present invention is the SP16 Storm-1 SoC processor from Stream Processors Inc.

MMU 308 provides access to dynamic random access memory (DRAM 318) for implementing video data storage buffers utilized by SDI mux/demux 306 and TS mux/demux 310 for storing input and output video and audio data. SDI mux/demux 306 has external I/O ports HD-SDI port 321a, HD-SDI port 321b, HD-SDI loopback port 321c, and has internal I/O connections to DRAM 318 through MMU 308 including embedded video I/O 321e and embedded metadata I/O 321f. SDI-mux/demux may stream digital audio to and from audio crossconnect via digital audio I/O 321d. A set of external AES/EBU audio ports 323a-d is also connected to audio crossconnect 312 which functions to select from the signal on audio ports 323a-d or the signal on digital audio I/O port 321d for streaming to DRAM 318 through MMU 308 on embedded audio connection 323b.

Transport stream mux/demux 310 has DVB-ASI interfaces 322a, 322b and DVB-ASI loopback interface 322c. TS mux/demux 310 may also generate or accept TS over IP data packets via 10/100/1000 Base-Tx Ethernet port 322d. TX mux/demux 310 conveys MPEG-2 transport streams in network or transmission applications. MPEG-2 video data streams may be stored and retrieved by accessing DRAM 318 through MMU 308.

MMU 308, SDI mux/demux 306, TS mux/demux 310 and audio crossconnect 312 functions are preferably implemented in programmable hardware such as a field programmable gate array (FPGA). Encoder and decoders are implemented in reprogrammable software running on DSP microprocessor 301. Boot controller 320 and PCI controller 325 are implemented as system control programs running on DSP microprocessor 301.

To implement an encoder, DSP microprocessor 301 operates programmed instructions for encoding and compression of an SMPTE 292M standard HD-SDI transport stream into a MPEG-2 transport stream. SDI mu/demux 306 is programmed to operate as a SDI demultiplexer on input transport streams from HD-SDI I/O ports 321a and 321b with output embedded video and audio streams placed in video and audio data buffers implemented in DRAM 318, TS mux/demux 310 is programmed to operate as a TS multiplexer, taking its input audio and video data stream from DRAM 318 and streaming its multiplexed transport stream selectably to DVB-ASI port 322a, DVB-ASI port 322b or TS over IP port 322d. Video and audio encoder running on DSP microprocessor 301 accesses stored video and audio data streams in DRAM 318 to perform the encoding and compression functions.

To implement a decoder, DSP microprocessor 301 operates programmed instructions for decompression and decoding of a MPEG-2 transport stream into an SMPTE 292M HD-SDI transport stream. SDI mux/demux 306 is programmed to operate as a SDI multiplexer with output transport streams sent to HD-SDI I/O ports 321a and 321b with input embedded video and audio streams captured from video and audio data buffers implemented in DRAM 318, TS mux/demux 310 is programmed to operate as a TS demultiplexer, sending its output audio and video data stream to DRAM 318 and streaming its input transport stream selectably from DVB-ASI port 322a, DVB-ASI port 322b or TS over IP port 322d. Video and audio decoder running on DSP microprocessor 301 accesses stored video and audio data streams in DRAM 318 to perform the decompression and decoding functions.

In the preferred embodiment DRAM 318 is shared between a host system connected through PCI bus 326 and codec system 300.

The hardware platform being centered around a DSP processing engine are flexible and extendable to input interfaces and bit rates, video framing formats, compression methods, file storage standards, output interfaces and bit rates and to given user requirements per a given deployed environment so that many further embodiments are envisioned by adjusting the firmware or software programs residing on either given hardware platform.

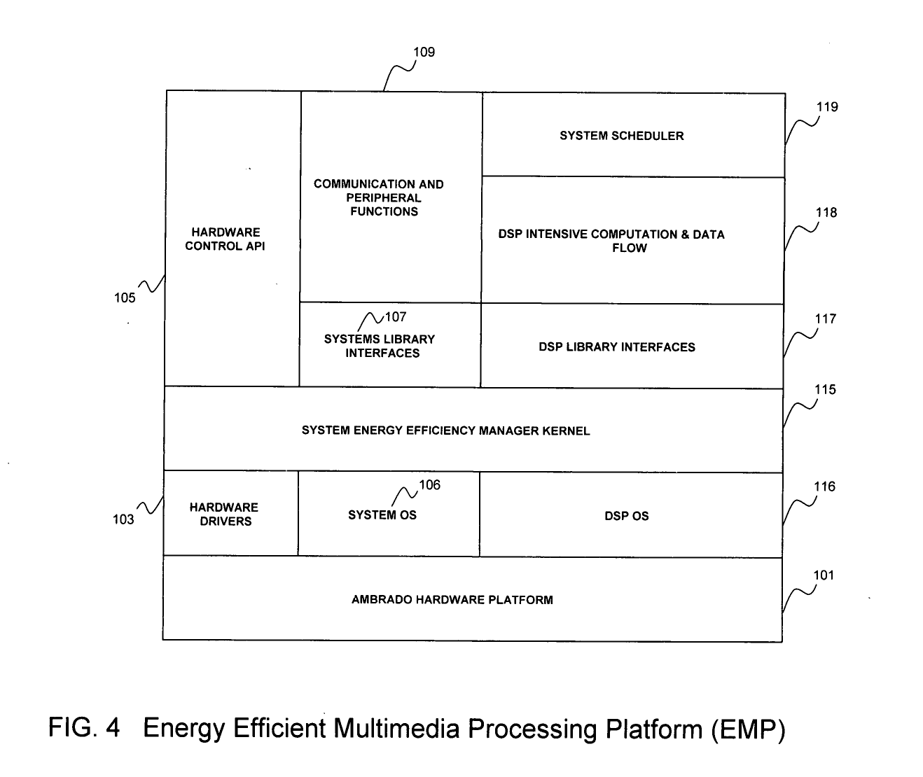

The software framework and programmable aspects of the present invention are explained with the help of FIGS. 4, 5 and 6. Codec software system, described by the software framework 100 of FIG. 4, operates on hardware platform 101 which has functional components consistent with first embodiment codec system 300 of FIG. 3. Software framework 100 executes under a pairing of two operating systems, the system OS 106 and the DSP OS 116, running on DSP microprocessor 301 in codec system 300. In the preferred embodiment, the system OS is an embedded Linux OS and the DSP OS is RTOS. Under these two operating systems, Codec software framework 100 comprises a set of modules that permit rapid adaptation to changing standards as well as customization to users specific needs and requirements with a short development cycle.

Software framework 100 has the capability to intelligently manage system power consumption through systems energy efficiency manager (SEEM) kernel 115 which is programmed to interact with various software modules, including modules that can adaptively control system voltage. SEEM kernel 115 monitors required speed and required system voltage while in different operational modes to ensure that required speed and voltage are maintained at minimum necessary levels to accomplish required operations. SEEM kernel 115 enables dramatic power reduction over and above efficient power designs chosen in the hardware systems architecture level, algorithmic level, chip architecture level, transistor level and silicon level optimizations.

System OS 106 further interfaces to a set of hardware drivers 103 and a set of hardware control APIs 105 and forms a platform that utilizes systems library module 107 along with the communications and peripheral functions module 109 to handle the system work load. Systems library module 107 contains library interfaces for functions such as video device drivers and audio device drivers while communications and peripheral functions module 109 contains functions such as device drivers for RS232 interfaces and panel control functions if they are required. System OS 106 also handles the system function of servicing the host interface in a hosted environment, the host interface physically being PCI controller 325 controlling PCI bus interface 326 in first embodiment codec system 300.

DSP OS 116 handles the execution of DSP centric tasks and comprises DSP library interfaces 117, DSP intensive computation and data flow 118, and a system scheduler 119. Examples of DSP centric tasks include codec algorithmic functions and video data streaming functions. The system scheduler 119 manages thread and process execution between the two operating systems.

Software framework 100 is realized in the embodiments described herein and is named in corresponding products from Ambrado, Inc as the Energy Efficient Multimedia Processing Platform (EMP).

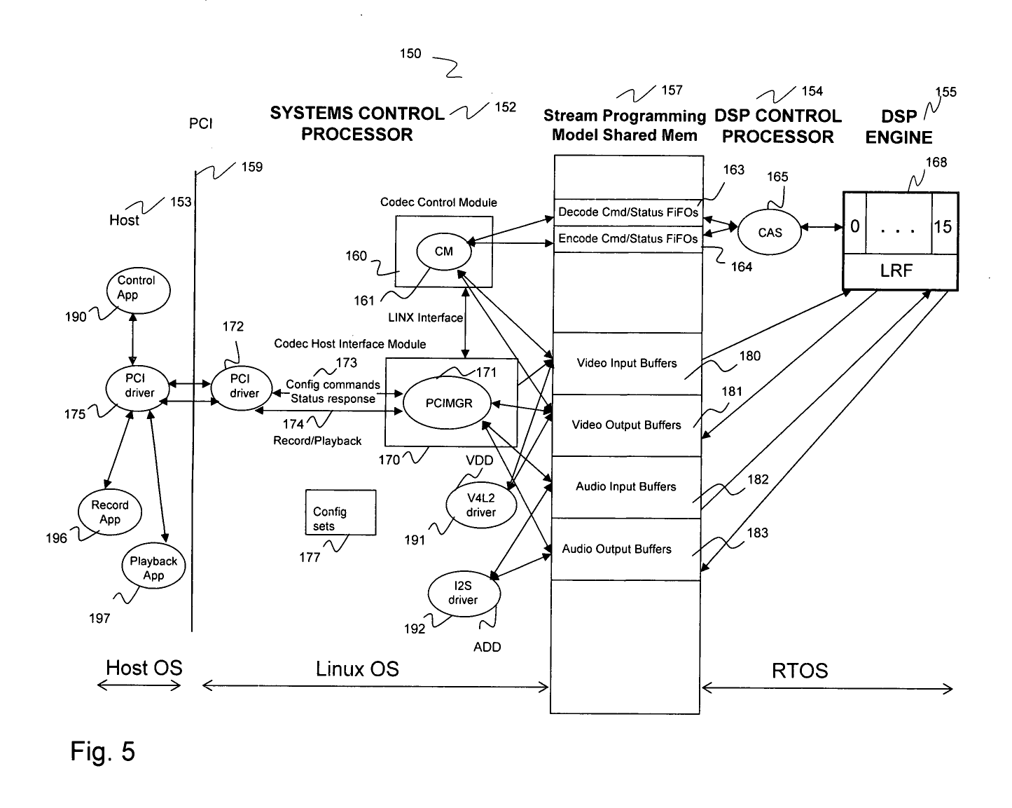

Codec software system of software framework 100 is organized into a set of modular components which are shown in FIG. 5. Components in the architecture represent functional areas of computation that map to subsystems of processes and device drivers, each component having an associated set of responsibilities and behaviors as well as support for inter-component communication and synchronization. Components do not necessarily map directly to a single process or single thread of execution. Sets of processes running on the DSP processor typically implement responsibilities of a component within the context of the appropriate OS. The principal components of the codec software system of the present invention are a codec manager, a PCI manager, a Codec Algorithmic Subsystem (CAS), a video device driver (VDD) and an audio device driver (ADD).

Examining FIG. 5 in detail, codec software system 150 is comprised of systems control processor 152 operating within system OS 106 and utilizing programs running therein; DSP control processor 154 operating within DSP OS 116 and utilizing programs running therein; DSP engine 155 executing streams of instructions as they appear in the lane register files 168; a stream programming shared memory 157, which is memory shared between System OS 106 and DSP OS 116 so that data may be transferred between the two operating systems.

A host system 153 interacts with codec software system 150 via PCI bus interface 159, host system 153 comprising at least a PCI driver 175 for driving data to and from PCI bus interface 159, a user driven control application 190 for controlling codec functions, a record application 196 for recording video and audio in conjunction with codec system 150 and a playback application 197 for playing video and audio files in conjunction with codec system 150. Host system 153 is typically a computer system with attached storage media that operates programs under Microsoft Windows OS. Alternatively, the host operating system may be a Linux OS.

Systems control processor 152 operates principal system components including codec manager 161, PCI manager 171, video device driver VDD 191 and audio device driver ADD 192. Codec manager 161 is packaged as a set of methods programmed in codec control module 160. PCI manager 171 is packaged as a set of methods programmed in codec host interface module 170.

DSP control processor 154 operates a codec algorithmic subsystem CAS 165 which is a principal system component.

Shared memory 157 comprises memory containers including at least a decode FIFO stack 163 and an encode FIFO stack 164 for holding command and status data, a video input buffer 180 for holding ingress video stream data, a video output buffer 181 for holding egress video stream data, an audio input buffer 182 for holding ingress audio stream data and an audio output buffer 183 for holding egress audio stream data.

VDD 191 and ADD 192 principal components are standard in embedded processing systems, being realized by the Linux V4L2 video driver and the Linux 12S audio driver in the preferred embodiment. VDD 191 manages the video data input and output requirements of codec system 150 as required in the course of its operation, operating on the video output buffer to create egress video streams for direct video interfaces and operating on ingress video streams from direct video interfaces to store video streams in video input buffer 180. Similarly, ADD 192 handles the codec system's audio input and output requirements operating on the audio input and output buffers to store and retrieve audio streams, respectively.

PCI manager 171 communicates all codec management and control tasks between host system 153 and codec manager 161 via PCI bus interface 159 using PCI driver 172. More specifically, PCI manager 171 communicates configuration commands 173a and status responses 173b in addition to record/playback commands 174 to and from host system 153.

PCI manager 171 transfers ingress video and audio streaming data generated from host system 153 into video input buffer 180 and audio input buffer 182, respectively. It also transfers egress video and audio streaming data to host system 153 from the video output buffer 181 and audio output buffer 183, respectively.

For configuration programming, PCI manager 171 allows host system 153 to exercise broad or finely tuned control of the codec functions. With a broad control approach, host system 153 configures the codec system 150 with stored configuration groupings known as configuration sets 177 of which there are three primary types in the preferred embodiment: (a) factory default configuration, (b) default configuration and (c) current configuration and an array of user definable configuration sets. In the preferred embodiment there are sixty-four user definable configuration sets in the array. With the finely tuned control approach, host system 153 may change any of the configuration settings in the current configuration allowing for a flexible model for codec configuration management for a plurality of encoding and decoding requirements.

Codec algorithmic subsystem CAS 165 performs encoding and decoding of video and audio data. CAS 165 is made up of kernels implementing MPEG-2 encoding and decoding algorithms for both audio and video which are executed by DSP control processor 154 in conjunction with DSP engine 155 by manipulating and performing computations on the streams in the lane register files 168. CAS 165 receives its commands and responds with status data to decode FIFO stack 163 and encode FIFO stack 164.

Codec manager 161 manages user interfaces and communicates configuration and status data between the user interfaces and the other principal components of the codec system 150. System interfaces are serviced by the codec manager 161 including a command line interface (not shown) and PCI bus interface requests via PCI manager 171. Codec manager 161 is also responsible for configuration data validation such as range checking and dependency checking.

Codec manager 161 also performs hierarchical scheduling of encoding and decoding processes, ensuring that encoding and decoding processes operating on incoming video and audio streams get appropriate CPU cycles. Codec manager 161 also schedules the video and audio streams during the encoding and decoding processes. To perform these scheduling operations, Codec manager 161 communicates directly with Codec algorithmic subsystem 165. For encoding (and decoding) operations, codec manager 161 accepts configuration data from the host control application 190 (via PCI manager 171) and relays video encoding (decoding) parameters to CAS 165 using encode FIFO 164 (decode FIFO 163). Codec manager 161 also collects status updates on the operational status of CAS 165 during encoding (decoding) process phases, communicating status information to host system 153 as required. Another function of Codec manager 161 is to interact with the video input buffer 180 to keep CAS 165 input stream full and interacts with the video output buffer 181 to ensure enough output buffer storage for CAS 165 to dump processed video data without overrun.

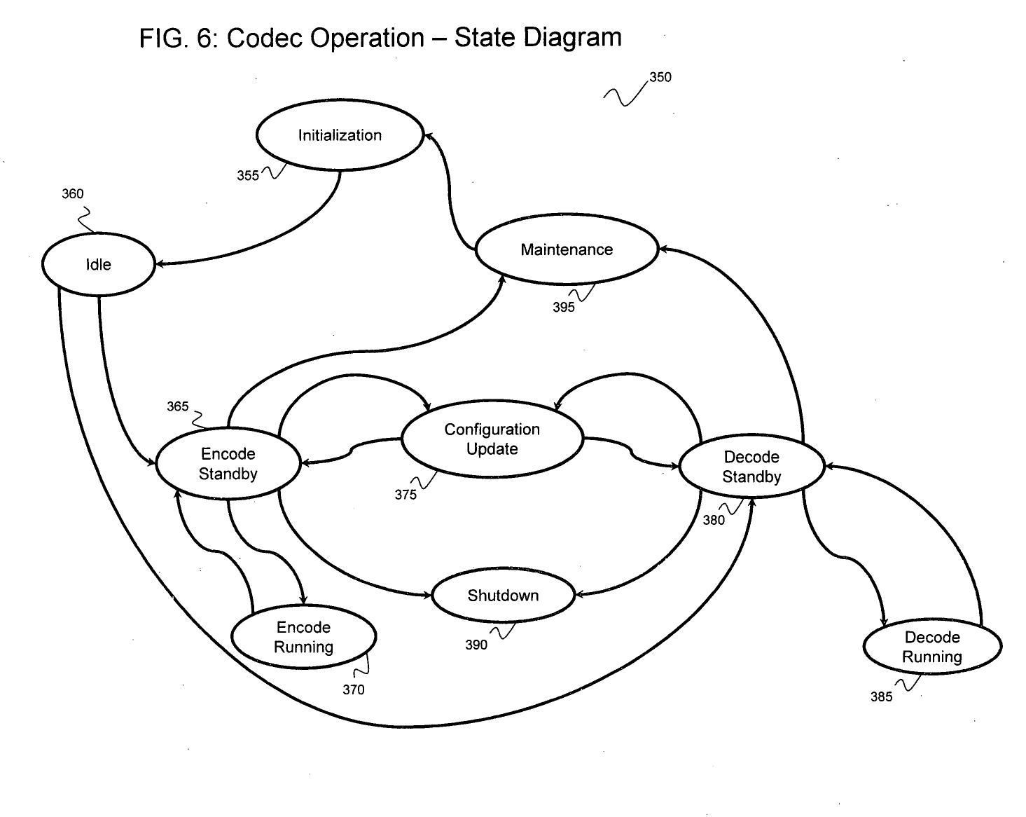

In operation, codec system 150 follows a sequence of operational states according to the state diagram 350 of FIG. 6. Interactions with codec system 150 to program the configuration and to change the operational mode causes codec system 150 to transition between the different operational states of FIG. 6.

Codec system 150 starts from the initialization state 355 while booting without any host system interaction. The system may be put into this state by sending an “INIT” command from PCI manager 171 to codec manager 161. During the initialization state the codec system boots, loading program instructions and operational data from flash memory. Once initialization is complete, codec system 150 transitions automatically to idle state 360, wherein the codec system is operational and ready for host communication. Codec manager 161 keeps the codec system in idle state 360 until a “start encode” or “start decode” command is received from the PCI manager 171. From idle state 360, the codec system may transition to either encode standby state 365 or decode standby state 380 depending upon the operational mode of the codec system being configured to encode or decode, respectively, according to the current configuration set.

Upon entering encode standby state 365, the codec system loads an encoder algorithm and is ready to begin encoding immediately upon receiving a “start encode” command from the host system via the PCI manager. When the “start encode” command is received by the codec manager, the codec system transitions from encode standby state 365 to encode running state 370. Encode standby state 365 may also transition to configuration update state 375 or to shutdown state 390 upon a configuration change request or a shutdown request from the host system, respectively. One other possible transition from encode standby state 365 is to maintenance state 395.

Encode running state 370 is a state in which the codec system, specifically the CAS 165, is actively encoding video and audio data. The only allowed transition from encode running state 370 is to encode standby state 365.

When entering decode standby state 380, the codec system loads a decoder algorithm and is ready to begin decoding immediately upon receiving a “start decode” command from the host system via the PCI manager. When the “start decode” command is received by the codec manager, the codec system transitions from decode standby state 380 to decode running state 385. Decode standby state 380 may also transition to configuration update state 375 or to shutdown state 390 upon a configuration change request or a shutdown request, respectively, from the host system. One other possible transition from decode standby state 380 is to maintenance state 395.

Decode running state 385 is a state in which the codec system, specifically the CAS 165, is actively decoding video and audio data. The only allowed transition from decode running state 385 is to decode standby state 380.

In configuration update state 375 a new configuration set is selected to be the current configuration set or the current configuration set is altered by the PCI manager. The only allowed transitions from the configuration update is to encode standby state 365 or decode standby state 380, depending upon the configuration setting.

Transitions to maintenance state 395 only arrive from encode standby state 365 or decode standby 330 when a major codec system issue fix or a software update is required. The software update process is managed by the PCI manager. The only possible transition from maintenance state 395 is to initialization state 355.

Transitions to shutdown arrive from encode state 365 or decode state 380 upon a power down request from PCI manager, wherein the codec system promptly powers down.

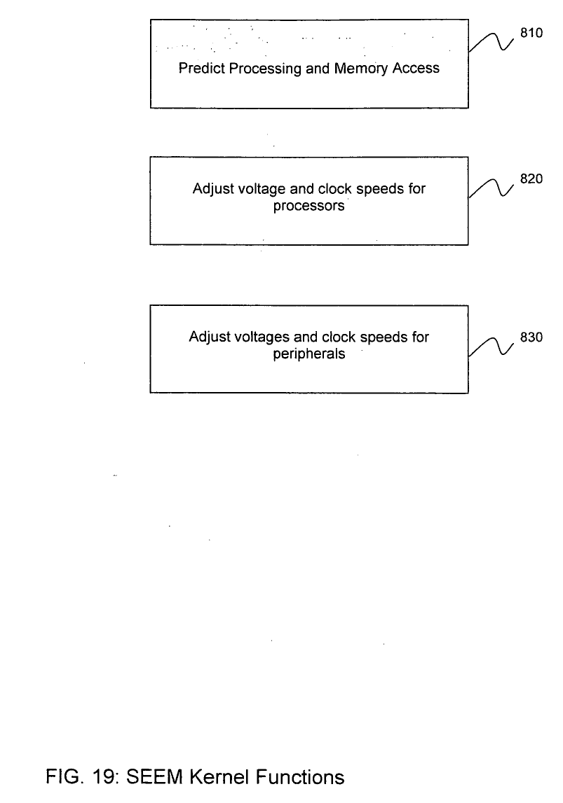

Energy efficiency of the codec system is managed in relation to the operational states of FIG. 6. SEEM kernel 115 of the codec software framework has three basic functions which are indicated in FIG. 19. Prediction function 810 proactively predicts processing and memory access requirements by different software components in operational phases to be executed, such as in playback or record operations. Processor adjustment function 820 adjusts voltage levels and clock speeds to processor elements in order to minimize necessary power in the operational phases. Peripheral adjustment function 830 adjusts voltage levels and clock speeds for peripheral devices as required by the operational phases.

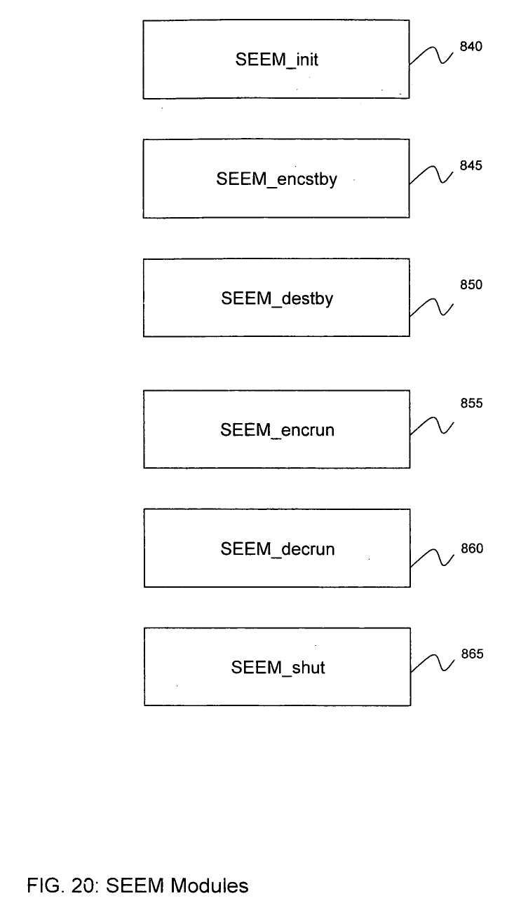

SEEM kernel 115 is examined in greater detail with the help of FIG. 20 which shows the executable SEEM components comprising SEEM kernel 115. Each SEEM component is associated to an operational state or to a transition between two operational states of the codec system.

SEEM_init 840 is a SEEM component that runs when the system is in initialization state 355 to parse all operational parameters passed to the system and based on impending operational requirements executes the following tasks:

i. initializes the voltage for the system to commence operation

ii. initializes the requisite clock speed

iii. idles all processor resources not required

iv. powers down and turns off the clocking signals to all peripherals not required

SEEM_encstby 845 is a SEEM component executing tasks similar to SEEM_init, except that it handles these tasks as operational/parametric requirements change during the transition from encode running state 370 to encode standby state 365 and back to encode running state 365. An example of a parametric change that changes operational requirements affecting power is when the encoder mode is changed from I-frame only encoding to LGOP frame encoding. Another relevant example is in when the constant bit rate requirement is changed from one output CBR rate to a different output CBR rate.

SEEM_destby 850 is a SEEM component executing tasks similar to SEEM_init, except that it handles these tasks as operational/parametric requirements change during the transition from decode running state 385 to decode standby state 380 and back to decode running state 385.

SEEM_encrun 855 is a SEEM component executing tasks similar to SEEM_init, except that it handles these tasks dynamically as needed while the codec system is in encode running state 365. For example, while a discrete cosine transform (DCT) is being computed the processor clock speed is increased by SEEM_encrun 855. Upon completion of the DCT, the encoder algorithm moves to a data transfer intensive mode that does not require processor cycles. SEEM_encrun 855 then idles the processor by reducing its clock rate and/or voltage level.

SEEM_decrun 860 is a SEEM component executing tasks similar to SEEM_init and SEEM_encrun, handling the tasks dynamically as needed while the codec system is in decode running state 385. SEEM_shut 865 performs an energy conserving system shutdown by appropriately powering off voltages and shutting down clock domains in sequences that do not compromise the systems ability to either switch back on at a later time or respond to a sudden request to reverse the shut-down process.

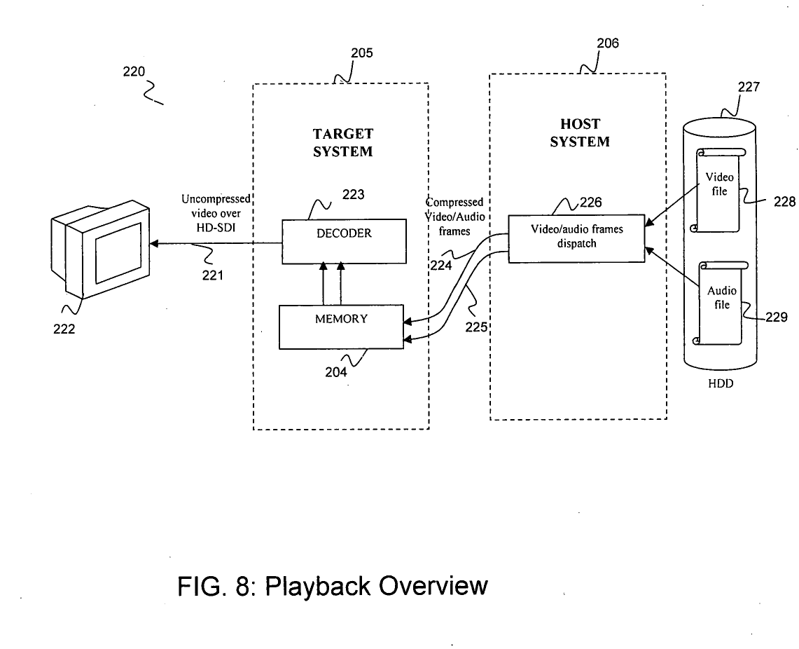

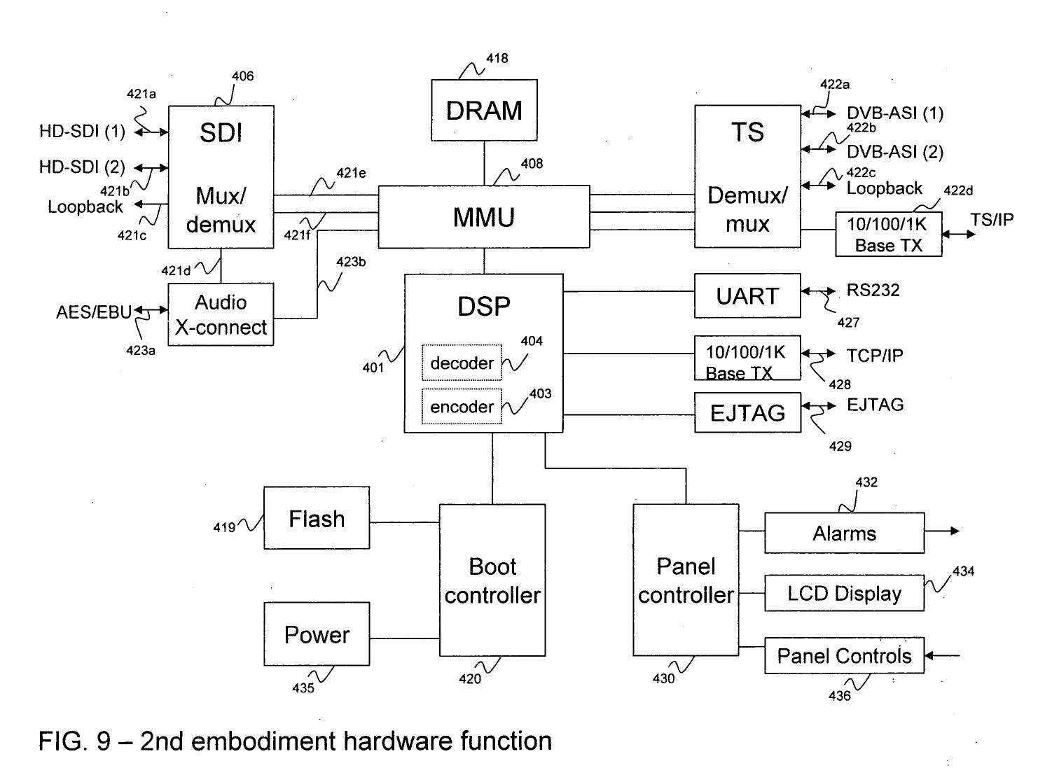

Once the codec system has appropriately been initialized and configured via the PCI manager, there are two essential user modes of operation shared between the host and codec system—the record mode and the playback mode. FIGS. 8 and 9 are used to describe these two modes.

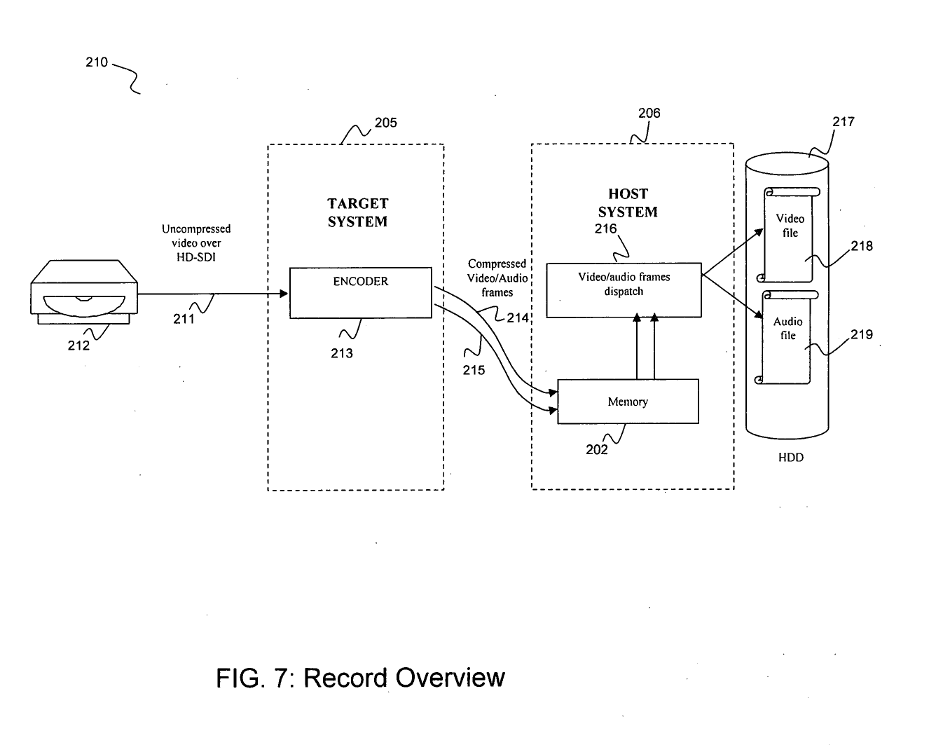

FIG. 7 is a block diagram of record function 210. Following the flow of data from left to right, a video/audio source 212, such as a DVD drive or HDTV camera sends an uncompressed HD-SDI transport stream 211 to the codec system (target) 205 which is configured to operate encoder 213. Encoder 213 encodes and compressed video stream 211 into encoded/compressed video stream 214 and audio stream 215. The streams 214 and 215 are written to shared memory 202 contained in host system 206 where the video and audio data is then stored by dispatch module 216 to video file 218 and audio file 219, respectively, on storage media device 217. Shared memory 202 is available to be written directly by the codec encoder 213 via direct memory access functions of the PCI bus in the preferred embodiment of the present invention.

FIG. 8 is a block diagram of the playback function 220. Following the flow of data from right to left, a video file 228 and audio file 229 is contained in storage media 227, the storage media being attached to host system 206. Video and audio data is retrieved by dispatch module 226 and transmitted as video stream 224 and audio stream 225 from host system 206 and stored into shared memory 204 contained within codec system 205 (target). Furthermore, codec system 205 is programmed to operate decoder 223 which decodes stored video and audio data from streams 224 and 225, respectively and outputs the decoded video and audio signals as an uncompressed HD-SDI transport stream 221 which is further displayed by video display device 222. Shared memory 204 is available to be written directly by the host system 206 via direct memory access functions of the PCI bus in the preferred embodiment of the present invention.

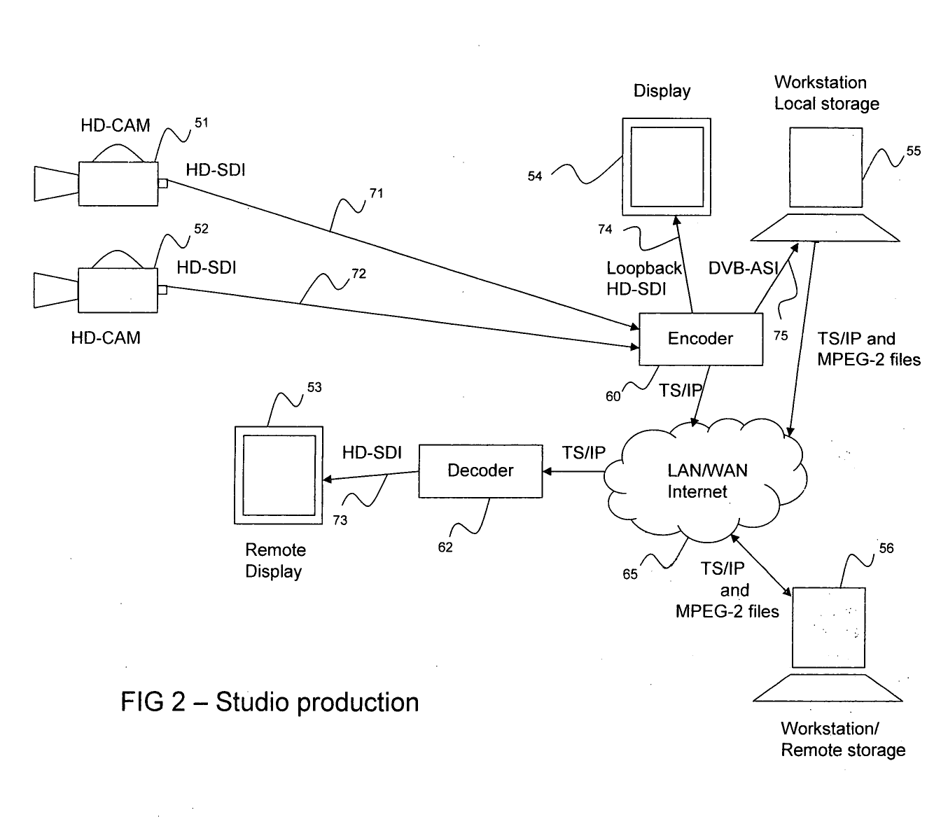

A second embodiment of the present invention is a production quality stand-alone codec system suitable for rack mount applications in a studio or video production environment. FIG. 2 shows stand-alone (SA) encoder 60 and stand-alone (SA) decoder 62 which may be separated physically from each from other or mounted in the same rack. Both SA encoder 60 and SA decoder 62 are connected to LAN/WAN IP routed network 65 which itself may be a part of the internet IP routed network. HD-camera 51 and HD-camera 52 output uncompressed HD-SDI signals 71 and 72, respectively on 75-ohm video cables, respectively, which are connected as input HD-SDI signals to SA encoder 60. A loopback HD-SDI signal 74, which is a copy of at least one of the raw uncompressed video signals 71 or 72, may be displayed on a first HD video monitor 54.

SA encoder 60 functions to encodes and compress at least one of the HD-SDI signals 71 and 72 into an MPEG-2 transport stream which may be further packetized into a DVB-ASI output signal 75 or a an MPEG-2 TS over IP packet stream which is sent to IP routed network 65 for transport to other devices such as SA decoder 62 and video workstation 56. SA decoder 62 may be used to monitor the quality of the MPEG-2 encoding process by decoding the MPEG-2 TS over IP packet stream to uncompressed HD-SDI signal 73 which is available for viewing on a second HD video display monitor 53. Video workstation 56 receives routed MPEG-2 TS over IP packet streams and may by used to display, edit, store and perform other video processing functions as is known in the art of video production.

One goal of the present invention is to provide SA encoder and SA decoder devices which are customized for the needs of the specific production environment. As production environment needs vary considerably from company to company and requirements evolve rapidly with standards, a need exists for software programmable SA encoder and decoder devices allowing for rapid development and deployment cycles.

FIG. 9 shows a functional diagram of codec system 400 of the second embodiment of the present invention which is very similar to first embodiment codec system 300 except that interfaces to a host system are replaced with panel control interfaces. Codec system 400 comprises a DSP microprocessor 401 to which memory management unit MMU 408, a SDI mux/demux 406, a transport stream (TS) mux/demux 410 and an audio crossconnect 412 are attached for processing video and audio data streams. DSP microprocessor 401 implements video/audio encoder functions 404 and video/audio decoder functions 403. DSP microprocessor 401 has interfaces RS232 PHY interface 427 and 10/100/1000 Base-Tx Ethernet interface 428 for external control, EJTAG interface 429 for hardware debugging and a panel controller 430 for controlling front panel functions including alarms 432, LCD panel display 434 and panel control keypad 436. Boot controller 420 is included to provide automatic bootup of the hardware system, boot controller 420 being connected to flash memory 419 which holds program boot code, encoder functional code and decoder functional code which may be executed DSP microprocessor 401. Power on/off switch 435 is sensed by boot controller 420 which controls the codec system shutdown and turn on processes.

DSP microprocessor 401 is a physical integrated circuit with CPU, I/O and digital signal processing hardware onboard. A suitable component for DSP microprocessor 401 having sufficient processing power to successfully implement the embodiments of the present invention is the SP16 Storm-1 SoC processor from Stream Processors Inc.

MMU 408 provides access to dynamic random access memory (DRAM 418) for implementing video data storage buffers utilized by SDI mux/demux 406 and TS mux/demux 410 for storing input and output video and audio data. SDI mux/demux 406 has external I/O ports HD-SDI port 421a, HD-SDI port 421b, HD-SDI loopback port 421c, and has internal I/O connections to DRAM 418 through MMU 408 including embedded video I/O 421e and embedded metadata I/O 421f. SDI-mux/demux may stream digital audio to and from audio crossconnect via digital audio I/O 421d. A set of external AES/EBU audio ports 423a-d also connected to audio crossconnect 412 functions to select from the signal on audio ports 423a-d or the signal on digital audio I/O port 421d for streaming to DRAM 418 through MMU 408 on embedded audio connection 423b.

Transport stream mux/demux 410 has DVB-ASI interfaces 422a, 422b and DVB-ASI loopback interface 422c. TS mux/demux 410 may also generate or accept TS over IP data packets via 10/100/1000 Base-Tx Ethernet port 422d. TX mux/demux 410 conveys MPEG-2 transport streams in network or transmission applications. MPEG-2 video data streams may be stored and retrieved by accessing DRAM 418 through MMU 408.

MMU 408, SDI mux/demux 406, TS mux/demux 410 and audio crossconnect 412 functions are preferably implemented in programmable hardware such as a field programmable gate array (FPGA). Encoder and decoders are implemented in reprogrammable software running on DSP microprocessor 401. Boot controller 420 and panel controller 430 are implemented as system control programs running on DSP microprocessor 401.

The encoder and decoder implementations as well as the software framework for second embodiment codec system 400 are similar to the implementations and framework for first embodiment codec system 300. Software framework for the second embodiment replaces PCI manager with a panel control manager and extended codec manager for controlling alarming functions and the human interface functions: LCD panel display functions and panel control functions. Buttons on the front display panel are used to change the operational mode of second embodiment codec system, a codec manager software component being the primary system component responsible to communicate with the front panel display. Software state diagram as described for first embodiment codec system also applies to second embodiment codec system.

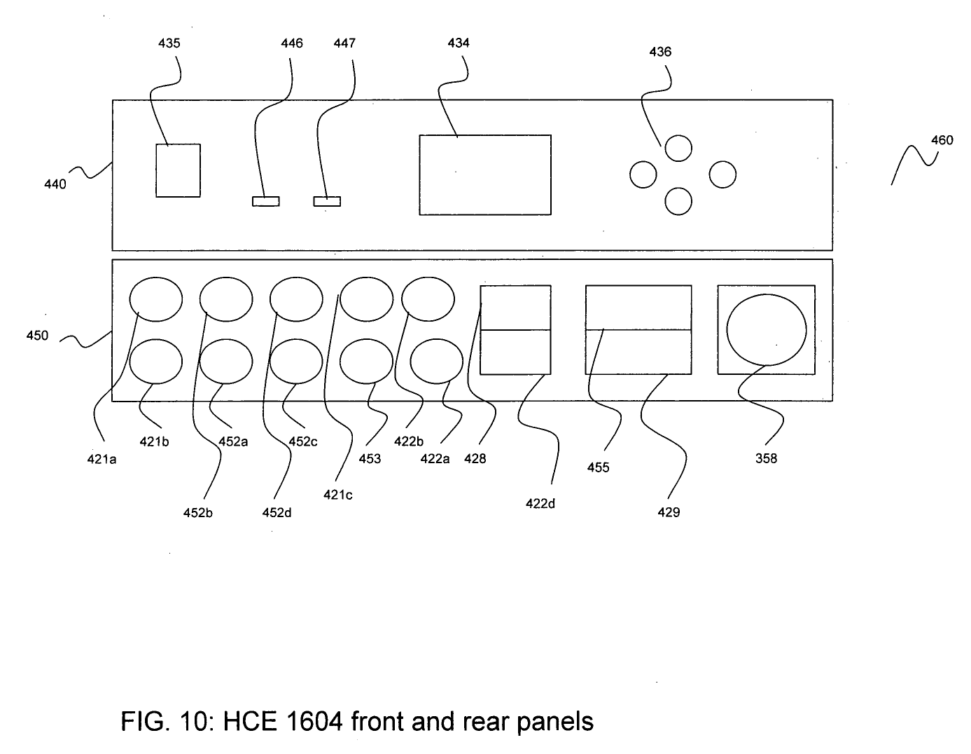

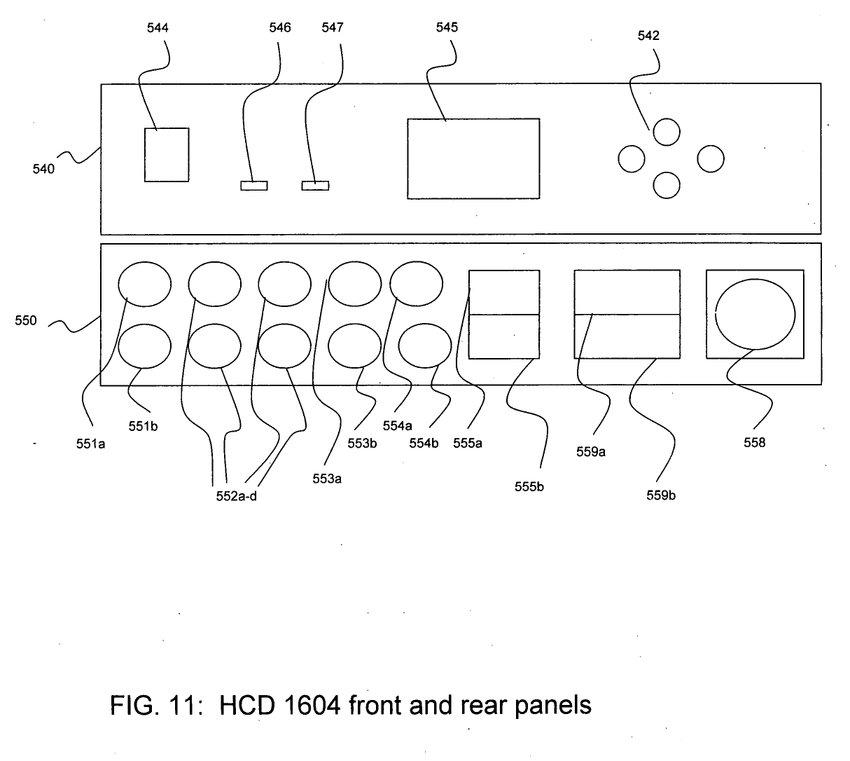

FIG. 10 provides further description of an encoder box 460 which embodies the hardware functions of codec system 400 programmed to implement a video and audio encoder. FIG. 11 provides further description of a decoder box 560 which embodies the hardware functions of codec system 400 programmed to implement a video and audio decoder. The encoder box 460 and decoder box 560 are realized in the HCE 1604 encoder and HCD 1604 decoder, respectively, from Ambrado, Inc.

A picture of the encoder box 460 front and back panels are shown in FIG. 10; the housing to which the front panel 440 and back panel 450 are attached is a metal box with dimensions X by Y by Z. Front panel 440 contains LCD panel display 434 that can be used to preview uncompressed input video. LCD panel display 434 also serves to display menu options which are controlled by means of panel control keypad 436 buttons (up/down/Enter/Escape). Encoder box 460 is configured via panel control keypad 436 or configured remotely via dedicated 10/100/1000 Mbps Ethernet port 428 using SNMP, Telnet based CLI and web based interface implemented in the system OS of DSP microprocessor 401. Encoder box 460 is further programmed to support collection and storage of information such as event logs of alarms, warnings and statistics of transmitted packets. Encoder box 460 is powered by a DC power supply which plugs into the back DC power port 458 requiring a voltage range of 10.5V to 20V, 12V nominal.; power on/off switch 435 is on the front panel.

Encoder box 460 supports a real time clock to keep track of its event logs, alarms and warnings; to maintain synchronization, the encoder box has a clock reference input 453. Event log data is saved in onboard flash memory and is available for user access. Ethernet 10/100/1000 Base-tx IP management port 428 is available on rear panel 450 for remote management of encoder functions. Encoder box 460 also has debug port 429 to connect to a local interface such as an EJTAG interface for hardware debugging and has a parallel alarm port 455 for remote monitoring of alarm signals 432. For local monitoring of alarm signals 432, front panel 440 contains alarm light 446 and status light 447. Encoder box 460 and decoder box 560 are half-rack in size so two boxes can be mounted in a single slot in any desired combination, for example one encoder box 460 and one decoder box 560.

Encoder box 460 has two HD/SD SDI I/O ports 421a and 421b for uncompressed video with embedded audio. One of the two HD/SD SDI signals on HD-SDI I/O ports 421a or 421b is selected for video/audio encoding and the selected HD/SD SDI signal is then driven to HD/SD SDI loop back I/O port 421c. Additionally, 4-pairs (8-channel) of external AES/EBU input audio signals 423a are connected via rear panel BNC connectors 452a-452d. Encoder box 460 is programmed to support the generation of color bars and a 1 KHz sine test signals for video and audio processing, respectively.

For output, encoder box 460 has two DVB-ASI I/O ports 422a and 422b providing two identical outputs for transmission of the DVB-ASI compliant MPEG Transport Stream (TS). Encoder box 460 allows for transmission of MPEG-2 TS over IP through dedicated 10/100/1000 Mbps (Gigabit) Base-TX Ethernet port 428. SDI and DVB video and AES/EBU audio ports typically utilize 75-ohm BNC type connectors. The Ethernet ports typically use RJ-45 connectors.

Similar to encoder box 460, decoder box 560 has front panel and rear panel connectors and controls. FIG. 11 shows the front panel 540 and rear panel 550 of a decoder box 560 having a chassis (not shown) of similar size to the encoder box 460. Front panel 540 includes power on/off switch 544, alarm light 546, status light 547, LCD display panel 545 and panel control keypad 542 all of which interact with the codec system 400 programmed to function as a decoder. On the rear panel, the DC power is connected through DC-in jack 558. DVB-ASI input signals are connected through BNC connectors 554a and 554b with DVB-ASI loopback port connected through BNC connector 553a. A reference clock may be connected to BNC connector 553b. Four channel AES/EBU audio signals are output on BNC connectors 552a-552d. After decoding the input MPEG-2 transport streams on DVB-ASI input signals, decoder box 560 outputs uncompressed HD-SDI standard SMPTE 292M signals on BNC connectors 551a and 551b. For remote management and control, a 10/100/1000 Base-TX IP Ethernet port 555a is provided on an RJ-45 connector, a set of digital alarm signals are made available on parallel connector 559a. A serial debug port 559b compatible with EJTAG is also provided. MPEG-2 TS over IP maybe connected through 10/100/1000 Base-TX Ethernet port 555b for streaming of TS IP packets to a routed network.

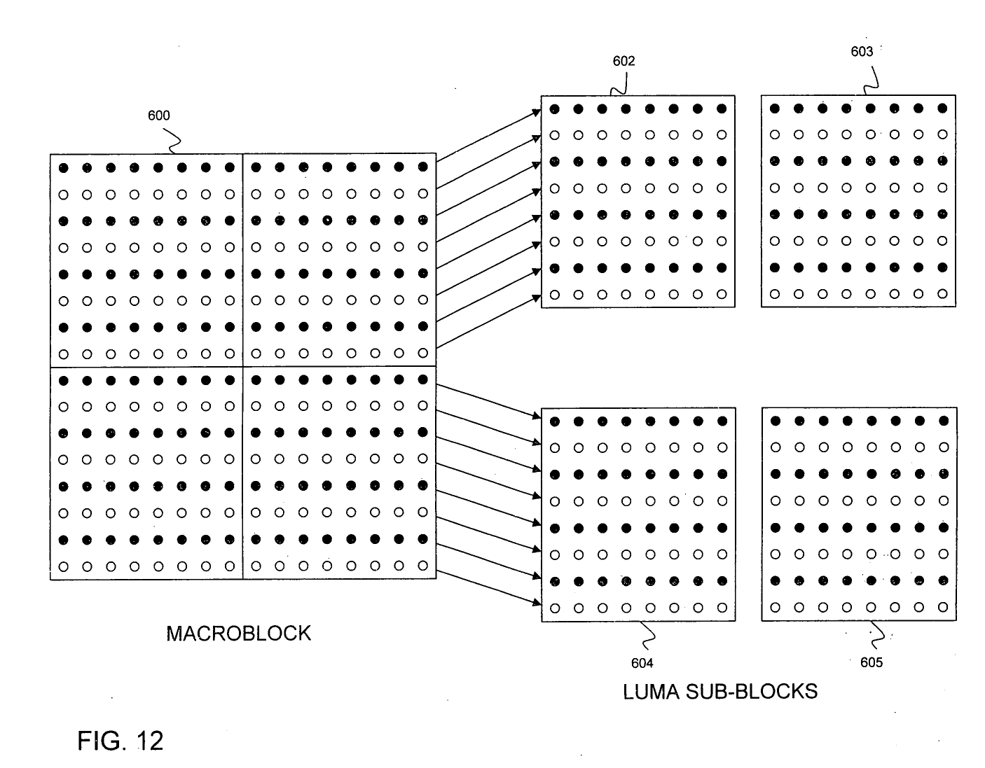

FIG. 12 is a drawing depicting luma samples of a video image consistent with interlaced framed pictures. The frame based encoder method is useful for encoding a frame-structured MPEG2 picture from an interlaced source. A 16×16 macroblock 600 comprises 16 rows and 16 columns with luma samples of alternate odd rows depicted by black dots and luma samples of alternate even rows depicted by open dots. The 16×16 macroblock is further partitioned into 4 8×8 sub-blocks. A first luma sub-block 602 is constructed of the upper left 8×8 sub-block. A second luma sub-block 603 is constructed of the upper right 8×8 sub-blocks. A third luma sub-block 604 is constructed of the lower left 8×8 sub-block. A fourth luma sub-block 605 is constructed of the lower right 8×8 sub-block.

The frame based encoder of the preferred embodiment operates separately on the 8×8 luma sub-blocks 602, 603, 604 and 605, applying DCT, quantization matrix and VLC methods thereto.

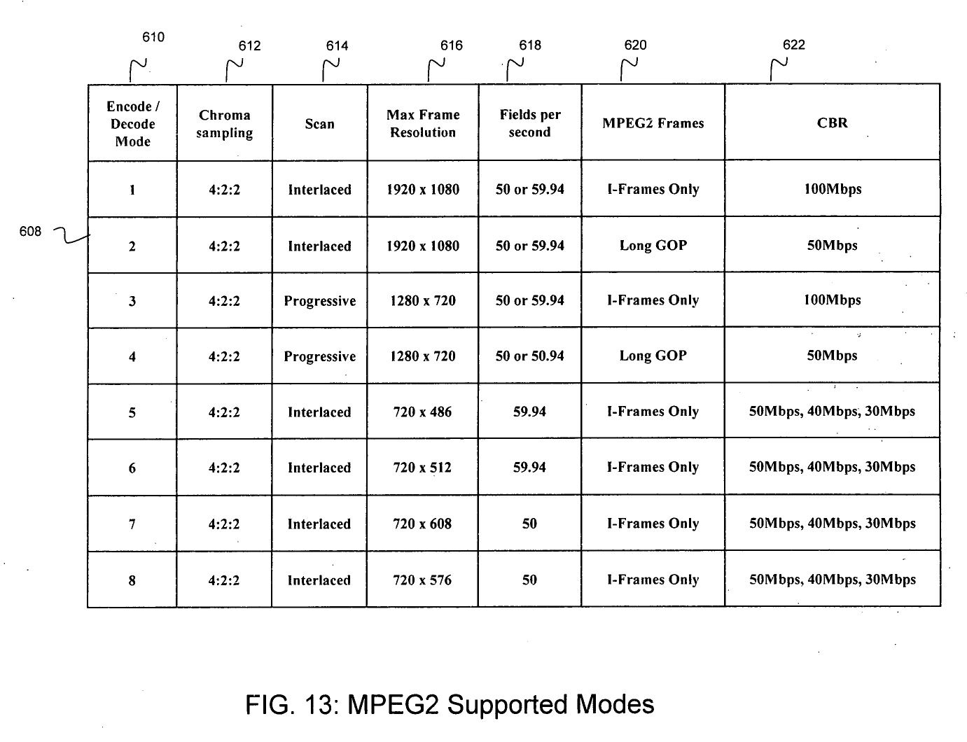

Preferred encoder modes as supported in the current embodiments are shown in the table 608 of FIG. 13, each encoder mode 610 producing a corresponding CBR bit rate 622 of 100 Mbps, 50 Mbps, 40 Mbps or 30 Mbps. Complete MPEG-2 frames 620 are constructed from interlaced or progressively scanned fields 614 containing a plurality of subblocks assembled into I-frames or long GOP (group of pictures) by the codec, the frames having corresponding resolutions 616. Field sampling rates 618 for each indicated encoder mode are also given in table 608. A preferred 4:2:2 chroma sampling scheme 612 is shown for the indicated encoder modes although additional samplings schemes and additional encoder modes may be supported.

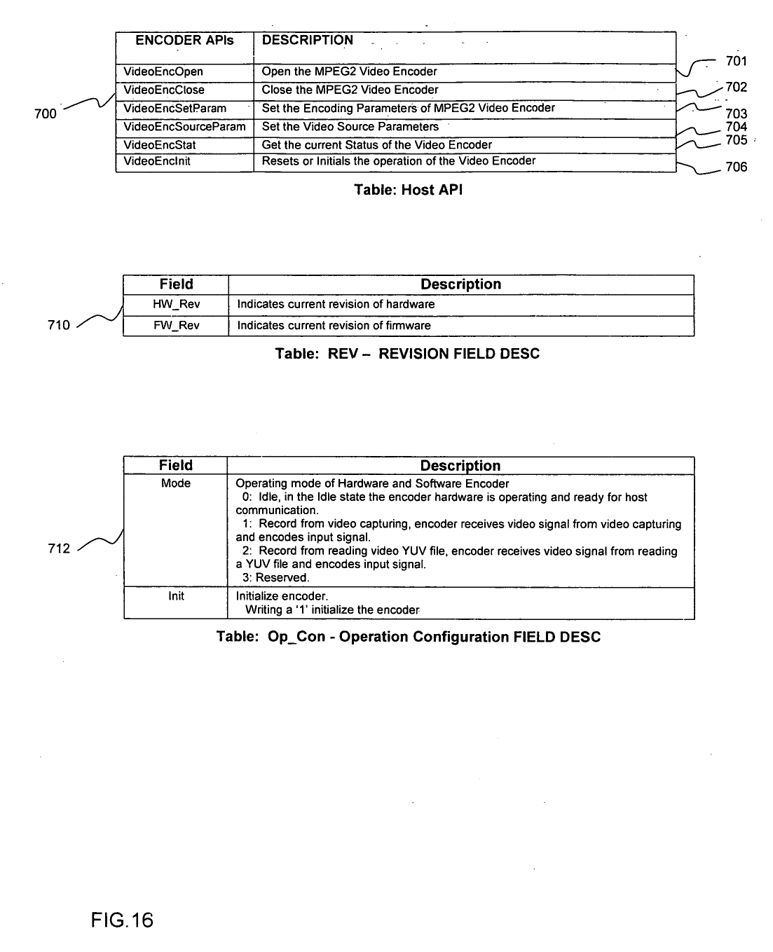

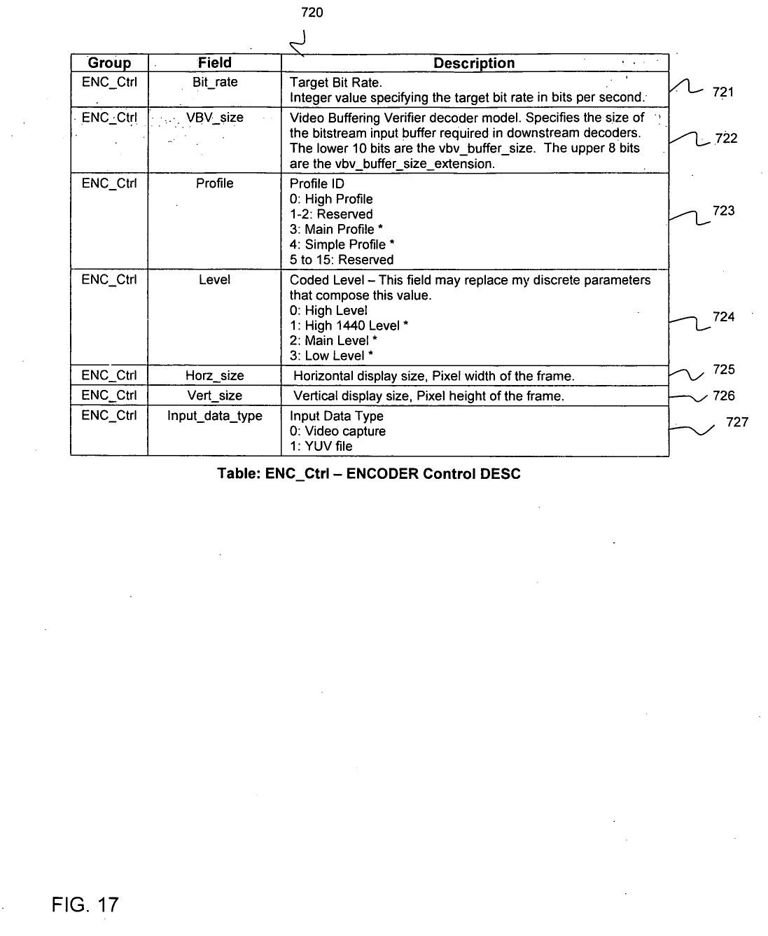

Upon encoding each complete frame into an MPEG-2 elementary transport stream, each transport stream packet record is augmented with a record header according to the record header format shown in FIGS. 16 and 17. Once the record header is packed, each frame is ready to be transported away, for example, to a host processor for storage or to an IP router for transport to another device on a routed network.

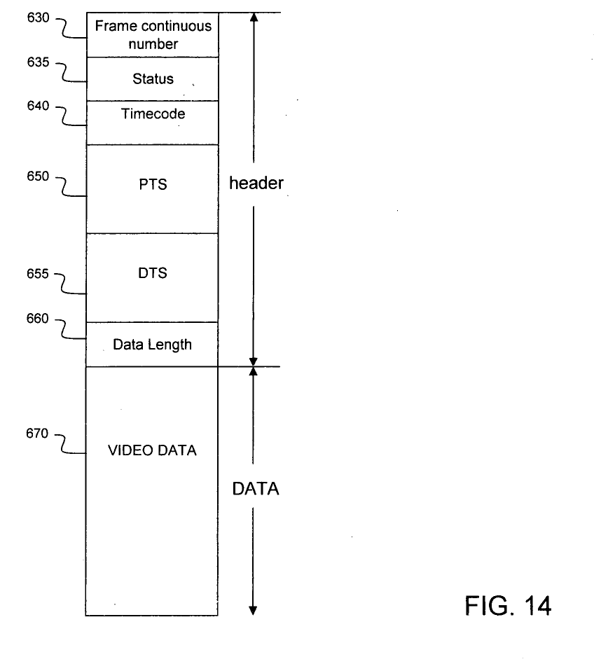

FIG. 14 indicates the fields of the record header: Frame continuous number 630, status 635, timecode 640, presentation time stamp (PTS) 650, decoding time stamp (DTS) 655, data length 660. Video data 670 follows the record header. In alternate embodiments, audio data and metadata may also be included in video data 670.

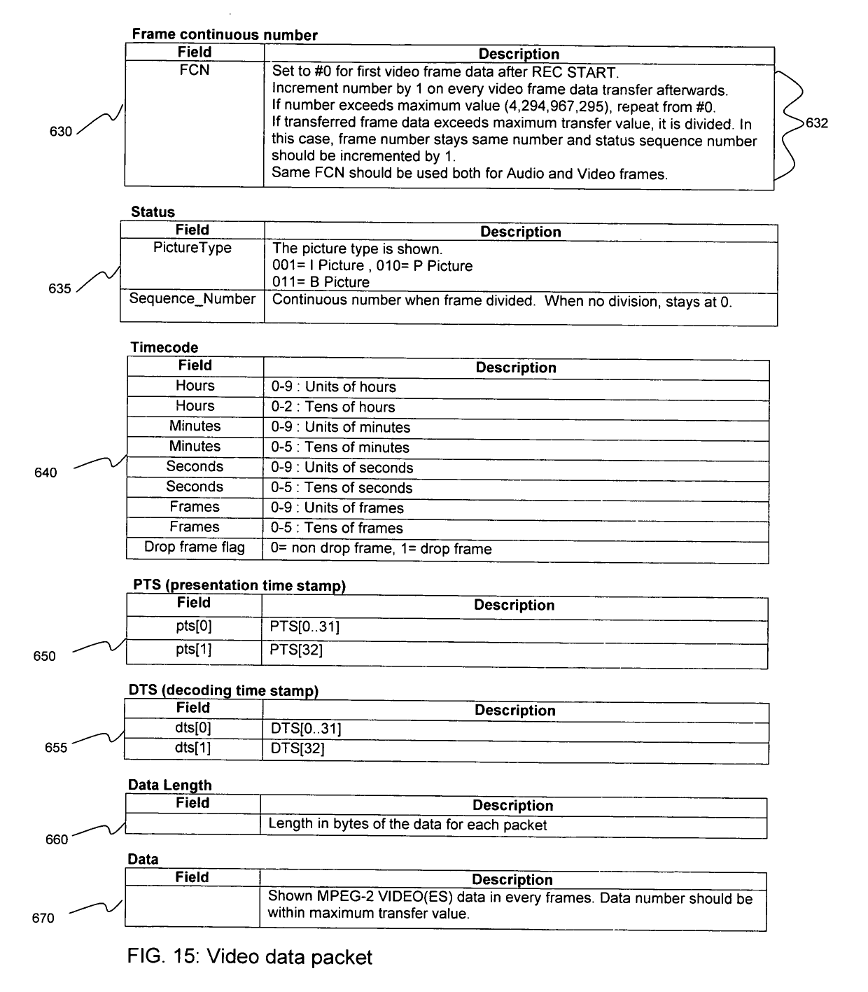

FIG. 15 shows the detailed record structure in the current embodiments. Frame continuous number FCN 630 is an index that increments on every frame transferred. Status 635 comprises two fields having a picture type selected from the set of (I Picture, P Picture and B Picture) and having a sequence number for further frame indexing. Method 632 indicates how FCN 630 is computed. For the first video frame after REC START, FCN is set to 0 (zero) and Status sequence_number is set to 0 (zero). FCN is incremented by 1 (one) on every video frame transfer thereafter. If the FCN exceeds a maximum (4,294,967,295 in the current embodiment), FCN starts incrementing from 0 (zero) again and Status sequence_number is incremented by 1.

Timecode 640 comprises 9 fields indicating hours, tens of hours, minutes, tens of minutes, seconds, tens of seconds, frames, tens of frames and a frame drop flag. PTS 650 has two fields containing the presentation time stamp in standard timestamp format. DTS 655 has two fields containing the decoding time stamp in standard timestamp format. Data length 660 indicates the length in bytes of the size of the packet. Video data 670 is the MPEG-2 video transport stream data.

A host software API in the context of the first embodiment codec system is specified for communications between the host and the encoder. Communications occurs by reading and writing commands and other information to specified memory locations (fields) which are shared between host and codec across the PCI bus interface. Table 700 of FIG. 16 shows a preferred set of API commands recognized and supported by the codec system, the set of API commands including commands to open a stream to the MPEG2 video encoder (command 701); close a stream to the MPEG2 video encoder (command 702); set the encoding parameters of the MPEG2 video encoder (command 703); set the video source parameters (command 704); get the current status of the video encoder (command 705); and to initialize the operation of the video encoder firmware and software (command 706).

The host software API may access or set encoder information. The function of reporting the current hardware and firmware revision is reported by two fields HW_rev and FW_rev as per table 710.

The host software API may read or write the operational configuration which is accomplished through a set of fields shown in table 712 as operating “Mode” field and operating “Init” field as per table 712. The operating “Mode” of the MPEG2 video encoder is set to one of four possible operating modes: mode 0 being an “idle” mode in which the encoder hardware is operating and ready for communication from the host; mode 1 being a “record from video capturing” mode wherein the encoder receives signal from an HD-SDI video stream and is capturing and encoding the video stream into the elementary transport stream; mode 2 being a “record from video YUV data file” mode wherein the encoder receives video signal from reading a YUV data file which is buffered in shared memory and encodes the file into an elementary transport stream. Operating “Init” field causes an initialization of the encoder firmware if the field value is set to ‘1’.

According to FIG. 17, host software API support functions include control and status parameters read and written to a set of control fields as per table 720. A “bit rate” field 721 sets the target CBR bit rate according to value of bits per second. A “VBV_size” field 722 sets the video buffering verifier decoder model specifying the size of the bitstream input buffer required in downstream encoders. A “profile” field 723 sets the MPEG2 profile type to one of (High Profile, Main Profile, and Simple Profile) and may include other MPEG profiles in alternate embodiments. A “level” field 724 sets the MPEG2 coded level to one of (High Level, High 1440 Level, Main Level, and Low Level). A “Horz_size” field 725 sets the pixel width of the encoded video frame. A “Vert_size” field 726 sets the pixel height of the encoded video frame. An “input_data_type” field 727 sets the input data to one of (Video capture, and YUV data file) which may be expanded to more input data sources as required by the codec hardware and application environment.

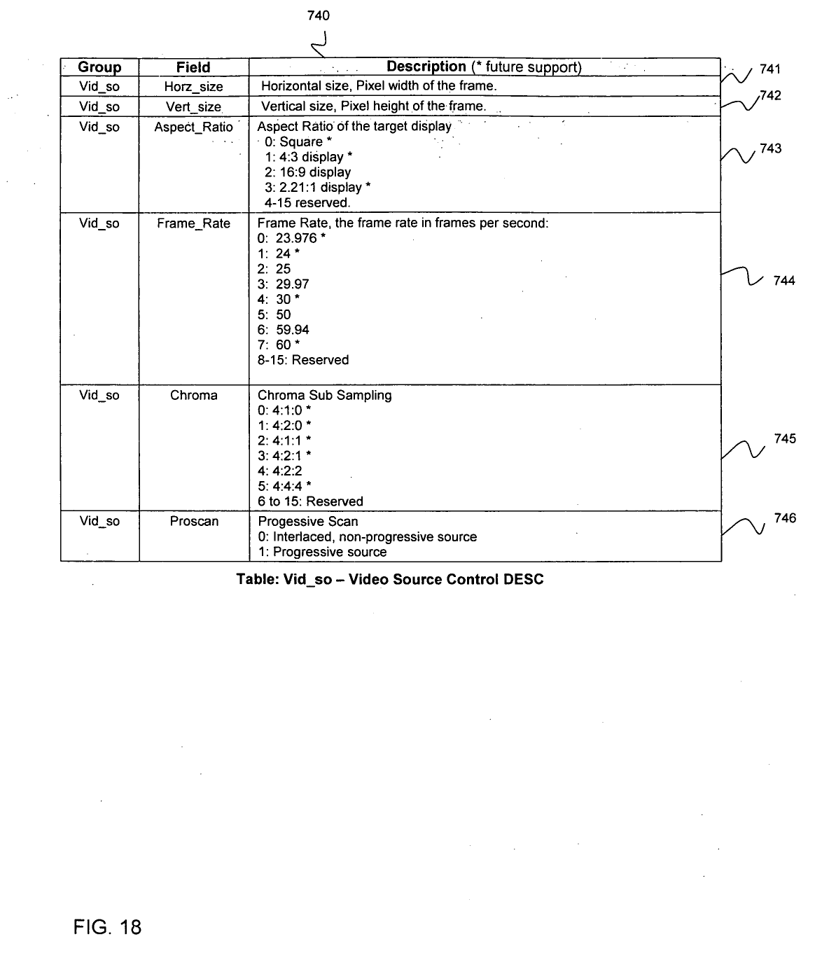

According to FIG. 18, host software API support functions may include the setting of information regarding the video source and is accomplished through the setting of fields as shown in Table 740. A “horz_size” field 741 specifies the pixel width of an incoming video frame. A “vert_size” field 742 specifies the pixel height of the incoming video frame. An “aspect_ratio” field 743 specifies the aspect ratio of the target display device to be one of (Square, 4:3, 16:9, 2.21:1) with reserved bit values for other aspect ratios. A “frame_rate” field 744 specifies the number of frames per second in the video stream according to the list (23.976, 24, 25, 29.97, 30, 50, 59.94, 60) frames per second with reserved bit values for other possible frame rates. A “chroma” field 745 specifies the chroma sub-sampling scheme according to the list (4:1:0, 4:2:0, 4:1:1,4:2:1, 4:2:2, 4:4:4) and reserved bit values for other schemes that may become important in future applications. A “proscan” field 746 specifies whether the video signal is a progressive scan type signal or an interlaced type signal.

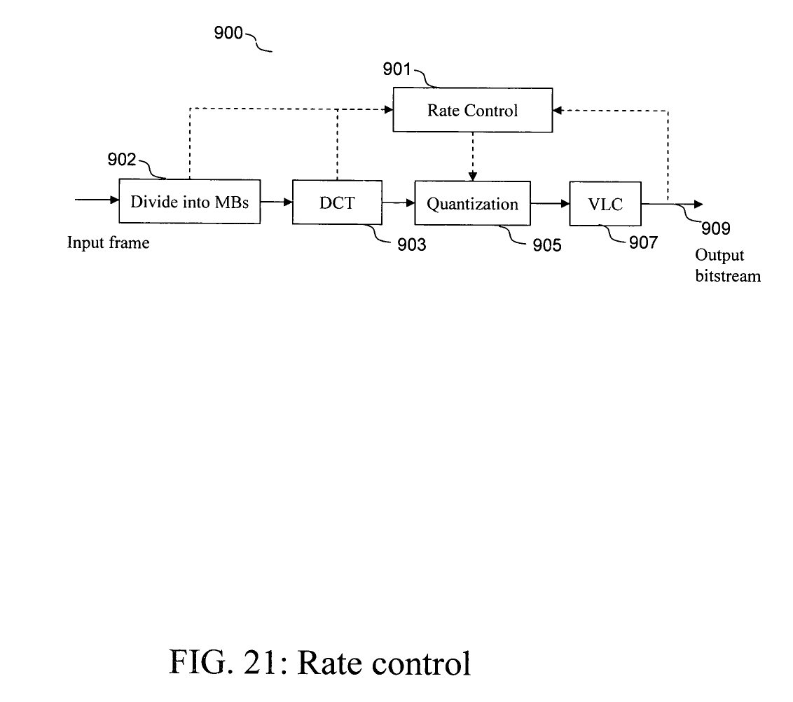

Turning now to the methods used for encoding in the codec systems of the present invention, the methods are described in the context of four processes as shown in FIG. 21: function 902 of breaking down of the frame into macroblocks (MB) and sub-blocks (SB) (c.f. FIG. 14), a transform of each macroblock and/or sub-block to spatial frequency in function 903 typically using a discrete cosine transform (DCT); function 905 of quantizing the DCT output according to a quantization parameter (QP); and a function 907 of variable length coding (VLC) which serializes the coded frame data into an output bitstream 909 which is typically a transport stream (TS) in the preferred embodiment. The four standard processes are usually performed in the given order in prior art systems.

A constant rate bit stream is accomplished through rate control function 901 and to adjust quantization parameters on-the-fly and per image slice. MB function 902 and DCT function 903 includes the ability to perform a prediction of quantization parameters which are fed forward to rate control function 901. Improvements in the encoding function and rate control function in general may be made over time and incorporated through program updates via the flash memory and by downloading via integrated ethernet interfaces.

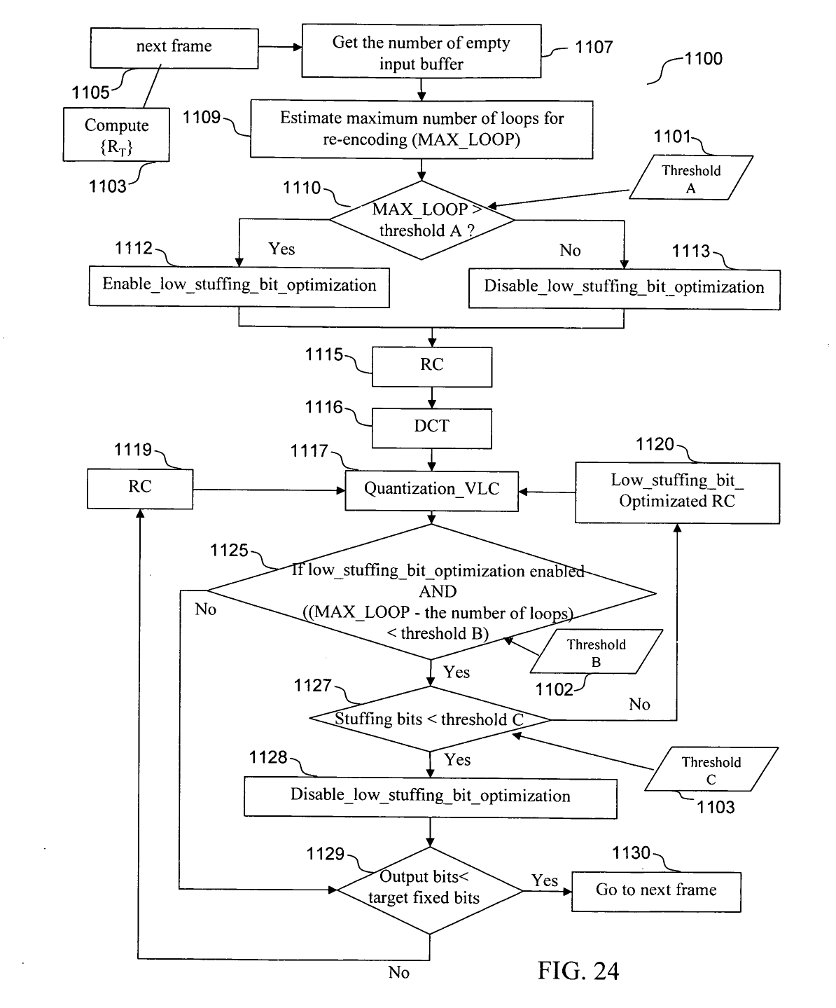

To achieve a constant number of output bits for every frame while maintaining high quality encoding and compression, rate control function 901 is operated by the DSP control processor in conjunction with the encoder processes consistent with SIMD structure parallel processing. The optimized bit allocation works to minimize stuffing bits. Bit allocation within a frame is controlled by the RC process which takes as its inputs: a computed complexity predictor prior to quantization and the actual bit stream bit rate after variable length encoding. The total output bits per frame are tuned by adjusting the quantization parameter (QP) for each master block within the frame according to the inputs using methodology and algorithms which are described in the methods of FIGS. 24 and 25.

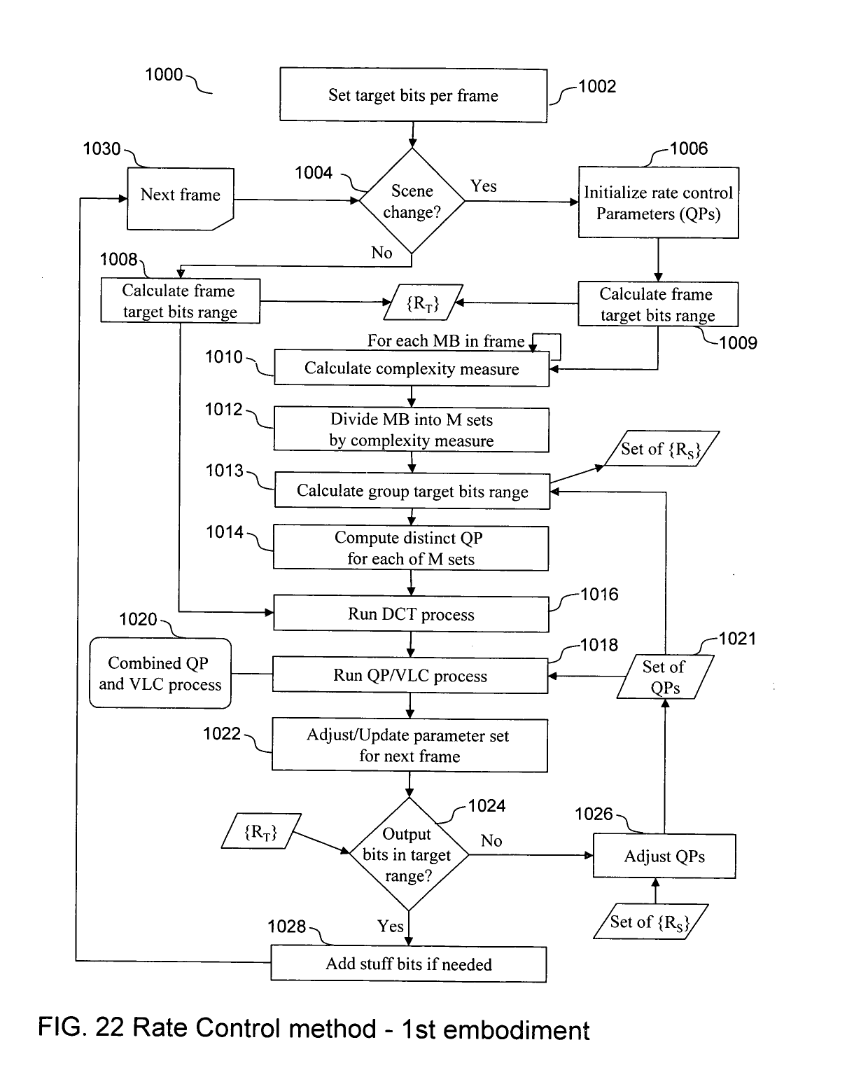

A first embodiment rate control method 1000 of the present invention is shown in FIG. 22. First rate control method 1000 starts at step 1002 of setting the number of target bits, R_{T}, for a set of frames to be encoded. Then each frame in the set is processed beginning at step 1004 wherein the frame is checked against the previous frame for a scene change. Upon a detected scene change or if the frame is the first frame in the set, then rate control parameters are initialized in step 1006 and a target range of bits, {R_{T}}, is computed for the current frame in step 1009.

The frame is then split into MBs and complexity measures are calculated in step 1010 for each MB in the frame. The MBs are further categorized into M sets in step 1012 according to the complexity measure of each MB and in step 1013, the target bits range {R_{T}} is subdivided into a set of M target ranges {R_{S}}. M distinct QPs are computed in step 1014 for each of the M sets in the frame, the distinct QPs forming the initial set of QPs 1021 for the MBs of the frame to be applied during quantization. Method 1000 then continues at step 1016. Complexity measures determine similarity between the current frame and previous encoded frame, for example scene change and motion complexity changes and will be described in more detail below.

If there is no scene change from the previous frame, step 1008 is performed on the current frame wherein a target range of bits, {R_{T}} is computed for the current frame based on the actual bits generated in the previous frame. The set of QPs 1021 for the previous frame become the initial set of QPs 1021 for the current frame to be applied during quantization. Rate control method 1000 then continues at step 1016.

In step 1016, a DCT process is run on each MB to transform the MBs of the frame into the spatial frequency domain.

An algorithm 1020 combining the quantization and VLC processes is run in step 1018 on the previously transformed MBs iterating through all of the MBs in the frame. The quantization utilizes quantization parameters from the set of QPs 1021, each MB mapped to one QP in the set.

After the quantization/VLC process for the current frame is completed, step 1022 stores the set of QPs 1021 for use as an initial set of QPs for the next frame.

A check is performed in step 1024 to determine if the actual number of output bits Rₒ is within the required target range {R_{T}}. If Rₒ is not in range, set of QPs 1021 is updated and adjusted in step 1026 wherein the set of M target ranges {R_{S}} is further checked for the output bits in each macroblock MB in the encoded frame. Also in step 1026, the set of frame complexity measures may be computed again, as in step 1010, to determine how the set of QPs 1021 need to be adjusted to ensure the required frame rate. The set of QPs 1021 are then adjusted accordingly and as needed.

Then the method continues to perform quantization/VLC step 1018 along with steps 1022, 1024 and 1026 repeatedly until the actual output bits are within the required range {R_{T}}.

Once Rₒ falls in the target range {R_{T}}or the process times out, stuff bits are added to the encoded frame in step 1028 to bring the number of frame bits to R_{T}.

After step 1028 the current frame is completely encoded, and the bit stream is pushed to the video output buffer in step 1030, after which the rate control method repeats at step 1004 with the next frame and continues until the video sequence of frames is completed or stopped.

In relation to first rate control method 1000, rate control function 901 of FIG. 21 comprises step 1004, step 1006, step 1008, step 1009, step 1010, step 1012, step 1013, step 1014, set of QPs 1021, step 1022, step 1024, step 1026 and step 1028.

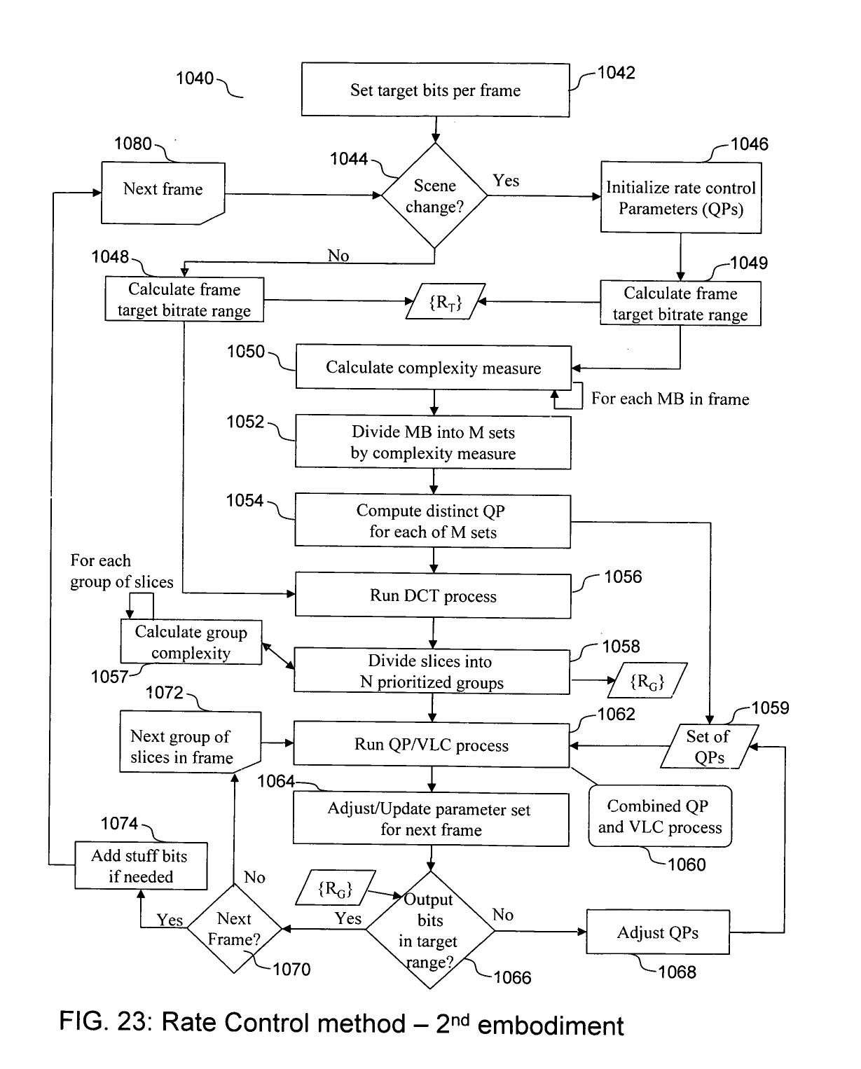

A second embodiment rate control method of the present invention is shown in FIG. 23. Second rate control method 1040 starts at step 1042 of setting the number of target bits R_{T}, for a set of frames to be encoded. Then each frame in the set is processed beginning at step 1044 wherein the frame is checked against the previous frame for a scene change. Upon a detected scene change or if the frame is the first frame in the set, then rate control parameters are initialized in step 1046 and a target range of bits, {R_{T}}, is computed for the current frame in step 1049.

The frame is then split into slices of MBs, each frame being constructed of a plurality of slices and each slice constructed of a set of MBs. Complexity measures are calculated in step 1050 for each MB in the frame. The MBs are further categorized into M sets in step 1052 according to the complexity measure of each MB. M distinct QPs are computed in step 1054 for each of the M sets in the frame, the distinct QPs forming the initial set of QPs 1059 for the MBs of the frame to be applied during quantization. Rate control method 1040 then continues at step 1056.

If there is no scene change from the previous frame, step 1048 is performed on the current frame wherein a target range of bits, {R_{T}} is computed for the current frame based on the actual bits generated in the previous frame. The set of QPs 1059 for the previous frame become the initial set of QPs 1059 for the current frame to be applied during quantization. Rate control method 1040 then continues at step 1056.

In step 1056, a DCT process is run on each MB to transform the MBs of the frame into the spatial frequency domain. After the DCT process completes, complexity measures are summed in step 1057 for each slice in the frame. The slices are then prioritized into N groups in step 1058 according to the complexity sum of each group of slices, highest priority groups of slices having the largest complexity sum and lowest priority groups of slices having the smallest complexity sum. Each group of slices is allocated a target range of bits {R_{G}}.

An algorithm 1060 combining the quantization and VLC processes is run in step 1062 on the previously transformed MBs iterating through all of the MBs in the highest priority group of slices, the quantization utilizing quantization parameters from the set of QPs 1059, each MB mapped to one QP in the set.

After the quantization/VLC process for the current group of slices is completed, step 1064 stores the set of QPs 1059 for use as an initial set of QPs for the corresponding slice of the next frame.

After encoding the current group of slices, a check is performed in step 1066 to determine if the actual number of output bits Rₒ is consistent with the required target range of bits {R_{G}}. If Rₒ is not in the range, the set of QPs 1059 is adjusted and updated in step 1068. Also in step 1068, the set of frame complexity measures may be computed again, as in step 1050, to determine how the set of QPs 1059 need to be adjusted to ensure the required frame rate. The set of QPs 1059 are then adjusted accordingly and as needed.

The rate control method 1040 continues to perform quantization/VLC step 1062 along with steps 1064 and 1066 repeatedly for the current group of slices until the actual output bits are within the required range {R_{G}}.

Step 1070 checks if the last group of slices has been processed and the frame is completely encoded. If the last group of slices in the frame has been processed then stuff bits are added to the encoded frame in step 1074 to bring the number of frame bits to R_{T}.

If the frame is not completely processed in step 1070, then the next lower priority group of slices is selected in step 1072 for processing and steps 1062, 1064, 1066 and 1068 are repeated as required until all of the N groups of slices are processed.

After step 1074 the current frame is completely encoded, and the bit stream is pushed to the video output buffer in step 1080, after which the rate control method repeats at step 1044 with the next frame and continues until the video sequence of frames is completed or stopped.

In relation to second rate control method 1040, rate control function 901 of FIG. 21 comprises step 1044, step 1046, step 1048, step 1049, step 1050, step 1052, step 1054, step 1057, step 1058, set of QPs 1059, step 1070, step 1072, step 1074, step 1064, step 1066 and step 1068.

The deviation of each MB, devMB, is used as the complexity measure in step 1010 of method 1000 and step 1050 of method 1040. MBs are divided into M groups based on the histogram of deviation of MBs in the frame. The group complexity measure in step 1057 for prioritizing the group of slices in method 1040 may use the sum of devMB for all the MBs in each slice or it may be computed as the a sum of the DCT coefficients from step 1056.

Assuming I(x, y) is the value of the luma component of pixel at (x,y), for one P×P macroblock, which includes four (P/2)×(P/2) blocks, the deviation of this macroblock is calculated according to the following equations:

$$devMB = {\sum }_{i = 0}^{3} {devBlock}_{i}$$

$${devBlock}_{0} = \frac{4}{P \times P} {\sum }_{y = 0}^{( P / 2 - 1 )} {\sum }_{x = 0}^{( P / 2 - 1 )} \vert I ( x , y ) - \frac{4}{P \times P} {\sum }_{y = 0}^{( P / 2 - 1 )} {\sum }_{x = 0}^{( P / 2 - 1 )} I ( x , y ) \vert$$

$${devBlock}_{1} = \frac{4}{P \times P} {\sum }_{y = 0}^{( P / 2 - 1 )} {\sum }_{x = P / 2}^{( P - 1 )} \vert I ( x , y ) - \frac{4}{P \times P} {\sum }_{y = 0}^{( P / 2 - 1 )} {\sum }_{x = P / 2}^{( P - 1 )} I ( x , y ) \vert$$

$${devBlock}_{2} = \frac{4}{P \times P} {\sum }_{y = P / 2}^{( P - 1 )} {\sum }_{x = 0}^{( P / 2 - 1 )} \vert I ( x , y ) - \frac{4}{P \times P} {\sum }_{y = P / 2}^{( P - 1 )} {\sum }_{x = 0}^{( P / 2 - 1 )} I ( x , y ) \vert$$

$${devBlock}_{3} = \frac{4}{P \times P} {\sum }_{y = P / 2}^{( P - 1 )} {\sum }_{x = P}^{( P - 1 )} \vert I ( x , y ) - \frac{4}{P \times P} {\sum }_{y = P / 2}^{( P - 1 )} {\sum }_{x = P / 2}^{( P - 1 )} I ( x , y ) \vert$$

In the embodiments of the present invention, FIFO frame buffers in memory are used to accept incoming frames from a video source. The encoder unloads the FIFO as the frames are encoded leaving empty frames available to accept incoming frames. A repeated encoding loop for quantization and VLC is prescribed within the rate control methods 1000 and 1040. See the steps 1021, 1018, 1022, 1024 and 1026 of method 1000 and the steps 1059, 1062, 1064, 1066 and 1068 of method 1040. The rate control methods with repeated encodings will optimize output bitstreams to have minimal stuffing bits for better quality and guarantees fixed output bits. However, the number of encoder loops should be limited, otherwise the input frame buffer queue fills and frames may be dropped, especially in the case where the incoming video source is real-time video capture.

FIG. 24 is a flow diagram of an encoder process 1100 which may be used in the context of the rate control process 900 of FIG. 21 to limit the number of encoder loops. It is noted that rate control steps 1115, 1119, and 1129 of FIG. 24 may comprise the steps: step 1004, step 1006, step 1008, step 1009, step 1010, step 1012, step 1013, step 1014, set of QPs 1021, step 1022, step 1024, step 1026 and step 1028 of method 1000. Rate control steps 1115, 119 and 1120 may alternatively comprise the steps: step 1044, step 1046, step 1048, step 1049, step 1050, step 1052, step 1054, step 1057, step 1058, set of QPs 1059, step 1070, step 1072, step 1074, step 1064, step 1066 and step 1068 of method 1040.

Encoder process 1100 begins by unloading the next frame into encoder memory from a frame buffer queue in step 1105. Once loaded, a target range of bits {R_{T}} is computed for the frame in step 1103 and the frame buffer queue is checked in step 1107 to get the number of empty input frames available for incoming video. Given the number of empty input frames, and the current frame rate, the maximum number of loops allowed for repeated encoded is estimated, MAX_LOOP. In step 1110, MAX_LOOP is compared to a pre-defined first threshold 1101. If MAX_LOOP is greater than or equal to first threshold 1101 then a low stuffing bit flag is enabled in step 1112, otherwise if MAX_LOOP is less than first threshold 1101, then low stuffing bit flag is disabled in step 1113. Encoder process 1100 continues with the rate control step 1115 and DCT in step 1116 followed by quantization and VLC in step 1117.

At step 1125 the low stuffing bit flag is checked and the number of loops L compared to MAX_LOOP. The number of loops is the number of times the quantization/vlc process in step 1117 has been repeated. L is equal to 1 (one) after the initial execution of quantization/VLC process in step 1117. If the low stuffing bit flag is enabled and (MAX_LOOPS-L) is less than a predefined second threshold 1102, then step 1127 is executed, otherwise step 1129 is executed.

Step 1127 checks the number of stuffing bits: if the number of stuffing bits is less than a pre-defined third threshold 1103 then the low stuffing bit flag is disabled in step 1128, otherwise step 1120 is performed. The number of stuffing bits is the difference between the actual bits generated for the encoded frame and a target number of bits.

Step 1129 checks if the output bits are within a frame target bit range. If the output bits are not in the frame target range then the rate control step 1119 is performed. Rate control step 1119 is essentially the same as rate control step 1115 and executes with the assumption that low stuffing bit optimization is not required. When low stuffing bit optimization is not required, rate control steps 1115 and 1119 allow for more rapid and coarse adjustment of quantization parameters. If, in step 1129, the output bits are within the frame target bit range, then the frame is considered to be encoded and the encoder process moves to the next frame in step 1130.

Rate control step 1120 is essentially the same as rate control step 1115 and executes with the assumption that low stuffing bit optimization is required. When low stuffing bit optimization is required, rate control steps 1115 and 1120 allow for fine adjustment of quantization parameters.

After rate control steps 1119 and 1120 finish, the quantization/VLC process in step 1117 and the steps that follow are repeated and the number of loops L incremented.

The specifications and description described herein are not intended to limit the invention, but to simply show a set of embodiments in which the invention may be realized. Other embodiments may be conceived for example, for current and future studio quality video formats which may include 3-D image and video content of current and future consumer formats for in-home theater such as the MPEG-4, H.264 format.

1. A method for frame based constant bit rate encoding of an uncompressed video data stream into a compressed video data stream by an encoder, the uncompressed video data stream composed of a sequence of frames, each frame being further composed of a plurality of slices, the slices further composed of macroblocks (MBs), each MB having a square block of P×P pixels, and wherein the encoder loads a current frame to be processed having stored information about a previous frame processed, the method comprising the steps of:
a) Setting a target range for the number of bits {R} per frame for the compressed video data stream;
b) Checking for a scene change occurring between the previous frame processed and the current frame;
c) Calculating a complexity measure for each MB in the current frame if the scene change occurred;
d) Computing a set of quantization parameters based on the complexity measure if the scene change occurred;
e) Transforming each MB in the current frame into a spatial frequency block;
f) Running a combined quantization and variable length coding (VLC) process on the spatial frequency block to compose an encoded frame for the compressed video data stream, wherein the combined quantization and VLC process utilizes the set of quantization parameters;
g) Counting the number of output bits in the encoded frame;
h) Adjusting the set of quantization parameters if the number of output bits in the encoded frame is outside of the target range for the number of bits {R};
i) Repeating the steps of running a combined quantization and VLC process, counting the number of output bits in the encoded frame and adjusting the set of quantization parameters until the number of output bits in the encoded frame is within the target range for the number of bits {R};
j) Repeating the steps beginning with checking for a scene change, wherein a next frame in the sequence of frames in the uncompressed video data stream is loaded into the encoder as the current frame.

2. The method of claim 1 comprising the additional step of adding stuff bits to the encoded frame after step i and before step j.

3. The method of claim 1 wherein the complexity measure for a MB is calculated as a deviation devMB where I(x, y) is the value of a luma component of a pixel at row x and column y of the square block of P×P pixels of the MB according to the steps:
$$devMB = {\sum }_{i = 0}^{3} {devBlock}_{i}$$
$${devBlock}_{0} = \frac{4}{P \times P} {\sum }_{y = 0}^{( P / 2 - 1 )} {\sum }_{x = 0}^{( P / 2 - 1 )} \vert I ( x , y ) - \frac{4}{P \times P} {\sum }_{y = 0}^{( P / 2 - 1 )} {\sum }_{x = 0}^{( P / 2 - 1 )} I ( x , y ) \vert$$
$${devBlock}_{1} = \frac{4}{P \times P} {\sum }_{y = 0}^{( P / 2 - 1 )} {\sum }_{x = P / 2}^{( P - 1 )} \vert I ( x , y ) - \frac{4}{P \times P} {\sum }_{y = 0}^{( P / 2 - 1 )} {\sum }_{x = P / 2}^{( P - 1 )} I ( x , y ) \vert$$
$${devBlock}_{2} = \frac{4}{P \times P} {\sum }_{y = P / 2}^{( P - 1 )} {\sum }_{x = 0}^{( P / 2 - 1 )} \vert I ( x , y ) - \frac{4}{P \times P} {\sum }_{y = P / 2}^{( P - 1 )} {\sum }_{x = 0}^{( P / 2 - 1 )} I ( x , y ) \vert$$
$${devBlock}_{3} = \frac{4}{P \times P} {\sum }_{y = P / 2}^{( P - 1 )} {\sum }_{x = P}^{( P - 1 )} \vert I ( x , y ) - \frac{4}{P \times P} {\sum }_{y = P / 2}^{( P - 1 )} {\sum }_{x = P / 2}^{( P - 1 )} I ( x , y ) \vert$$

4. The method of claim 1 wherein an additional step of grouping the MB into M sets of MBs according to complexity measures of each MB is performed subsequent to the step of calculating a complexity measure.

5. The method of claim 4 further comprising the steps of:
a) calculating M target bit ranges {R_{S}} for each set of MBs; and
b) utilizing the M target bit ranges {R_{S}} in the step of adjusting the quantization parameters.

6. The method of claim 4 wherein the step of computing the quantization parameters comprises the computing M quantization parameters for each of the M sets of MBs.

7. The method of claim 4 wherein the set of quantization parameters are stored as an initial set of quantization parameters for a subsequent frame to be encoded.

8. The method of claim 4 wherein the step of adjusting the set of quantization parameters includes the step of comparing complexity measures between the M sets of MBs.

9. The method of claim 1 having the additional steps of:
a) Summing the complexity measures for each MB and for each slice in the frame;
b) Forming N groups of slices according to the summed complexity measures; and,
c) Ordering the N groups of slices into priorities according to the summed complexity measures with a highest priority group of slices having the largest summed complexity measure and a lowest priority group of slices having the smallest summed complexity.

10. The method of claim 9 further comprising the steps of:
a) calculating N target bit ranges {R_{G}} for each group of the N groups of slices; and,
b) utilizing the N target bit ranges {R_{G}} in the step of adjusting the quantization parameters.

11. The method of claim 9 wherein the step of computing the set of quantization parameters comprises computing M quantization parameters for each of the M sets of MBs.

12. The method of claim 9 wherein the set of quantization parameters are stored as an initial set of quantization parameters for a subsequent frame to be encoded.

13. The method of claim 9 wherein the step of adjusting the set of quantization parameters includes comparing the summed complexity measures.

14. The method of claim 9 wherein the combined quantization and VLC process operates on a chosen group of slices from the N group of slices.

15. The method of claim 14, where the step of repeating the steps of running the combined quantization and VLC process, counting the number of output bits in the encoded frame and adjusting the set of quantization parameters is repeated for each group of slices from the N group of slices, starting from the highest priority group of slices and proceeding to the lowest priority group of slices.

16. The method of claim 15 wherein the step of counting the number of output bits in the encoded frame includes a substep of counting a number of output bits in each group of slices of the N group of slices.

17. A method for frame based constant bit rate encoding of an uncompressed video data stream into a compressed video data stream by an encoder having constant bit rate R, the uncompressed video data stream composed of a sequence of frames, each frame composed of macroblocks (MBs), each MB having P pixels, wherein the encoder operates on frames in an input frame buffer to produce an encoded frame, the method comprising the steps of:
a) Initializing the input frame buffer with empty frames;
b) Loading the input frame buffer with the sequence of frames;
c) Loading the encoder with a first frame from the input frame buffer;
d) Obtaining a number of empty frames remaining in the input frame buffer;
e) Determining a target range of bits for the encoded frame;
f) Estimating a maximum number of repetitive steps (MAX_LOOP) allowed during the encoding of the first frame into the encoded frame based on the number of empty frames remaining in the input frame buffer;
g) Comparing MAX_LOOP to a first threshold where if MAX_LOOP is greater than the first threshold, a low stuffing bit optimization is enabled and if MAX_LOOP is less than or equal to the first threshold, a low stuffing bit optimization is disabled;
h) Running a first rate control process to control a bit rate R of the compressed video data stream;
i) Transforming the MBs of the frame into a set of spatial frequency blocks;
j) Performing a combined quantization and variable length encoding (VLC) process on the set of spatial frequency blocks;
k) Setting a first state to true if both the low stuffing bit optimization is enabled and if MAX_LOOP is less than a second threshold, otherwise setting the first state to false;
l) If the first state is true then, performing the steps of:
i) Determining a number of stuff bits required for the encoded frame;
ii) Setting a second state to true if the number of stuff bits is less than a third threshold, otherwise setting the second state to false;
m) If the second state is true then disabling the low stuffing bit optimization; and
i) If the second state is false then performing the steps of:
(1) running a second rate control process; and,
(2) performing a combined quantization and variable length coding process;
n) Determining a number of bits in the encoded frame; and,
o) Repeating the step of running the first rate control process if the number of bits in the encoded frame is outside the target range of bits.

18. The method of claim 17 wherein the second rate control process operates to produce a smaller number of stuffing bits than that produced by the first rate control process.

19. An encoder system for performing frame based constant bit rate encoding of a sequence of uncompressed video frames into a sequence of compressed video frames wherein the frames are composed of a plurality of slices and the slices are composed of a plurality of macroblocks, MB(s), the encoder system comprising:
a) a digital signal processor;
b) a dynamic memory for storing the uncompressed and the compressed video frames;
c) a flash memory for storing program instructions;
d) a memory management unit connected to the dynamic memory and the flash memory, for moving uncompressed video frames from an input video stream into the dynamic memory and for moving compressed video frames from the dynamic memory to an output video stream;
e) an encoder processor implemented by the digital signal processor, the encoder processor programmed to:
i) transform each of the MB(s) of an uncompressed video frame in the sequence of uncompressed video frames into a set of spatial frequency blocks;
ii) perform a quantization process on each spatial frequency block of the set of spatial frequency;
iii) perform a variable length coding (VLC) process on each spatial frequency block of the set of spatial frequency blocks and to compose a compressed video frame of the sequence of compressed video frames from the set of spatial frequency blocks;
f) a rate control processor implemented by the digital signal processor, the rate control processor programmed to govern the number of bits of each of the compressed video frames in the sequence of compressed video frames, the rate control processor further programmed to
i) set a target range for the number of bits {R} per frame for the compressed video frames;
ii) check for a scene change occurring between a previous video frame processed and a current video frame;
iii) calculate a complexity measure for each MB in the current video frame if the scene change occurred;
iv) compute a set of quantization parameters based on the complexity measure if the scene change occurred;
v) cause the encoder processor to run a combined quantization and variable length coding (VLC) process, wherein the combined quantization and VLC process utilizes the set of quantization parameters;
vi) count the number of output bits in the compressed video frame;
vii) adjust the set of quantization parameters if the number of output bits in the compressed video frame is outside of the target range of bits {R};
viii) repeat the steps of causing the encoder processor to run a combined quantization and VLC process, counting the number of output bits in the compressed video frame and adjusting the set of quantization parameters until the number of output bits in the compressed video frame is within the target range of bits {R}; and,
ix) repeat the steps beginning with check for a scene change, wherein a next video frame in the sequence of uncompressed video frame is loaded into the encoder system as the current video frame.

20. The encoder system of claim 19 wherein the rate control processor is further programmed to add stuff bits to the compressed video frame.

21. The encoder system of claim 19 wherein the rate control processor is further programmed to calculate the complexity measure for each MB as a deviation, devMB, wherein I(x, y) is the value of a luma component of a pixel at row x and column y of the square block of P×P pixels of the MB according to the steps:
$$devMB = {\sum }_{i = 0}^{3} {devBlock}_{i}$$
$${devBlock}_{0} = \frac{4}{P \times P} {\sum }_{y = 0}^{( P / 2 - 1 )} {\sum }_{x = 0}^{( P / 2 - 1 )} \vert I ( x , y ) - \frac{4}{P \times P} {\sum }_{y = 0}^{( P / 2 - 1 )} {\sum }_{x = 0}^{( P / 2 - 1 )} I ( x , y ) \vert$$
$${devBlock}_{1} = \frac{4}{P \times P} {\sum }_{y = 0}^{( P / 2 - 1 )} {\sum }_{x = P / 2}^{( P - 1 )} \vert I ( x , y ) - \frac{4}{P \times P} {\sum }_{y = 0}^{( P / 2 - 1 )} {\sum }_{x = P / 2}^{( P - 1 )} I ( x , y ) \vert$$
$${devBlock}_{2} = \frac{4}{P \times P} {\sum }_{y = P / 2}^{( P - 1 )} {\sum }_{x = 0}^{( P / 2 - 1 )} \vert I ( x , y ) - \frac{4}{P \times P} {\sum }_{y = P / 2}^{( P - 1 )} {\sum }_{x = 0}^{( P / 2 - 1 )} I ( x , y ) \vert$$
$${devBlock}_{3} = \frac{4}{P \times P} {\sum }_{y = P / 2}^{( P - 1 )} {\sum }_{x = P}^{( P - 1 )} \vert I ( x , y ) - \frac{4}{P \times P} {\sum }_{y = P / 2}^{( P - 1 )} {\sum }_{x = P / 2}^{( P - 1 )} I ( x , y ) \vert$$

22. The encoder system of claim 19 wherein the rate control processor is further programmed to group the MB into M sets of MBs according to complexity measures of each MB and calculating the complexity measures for each MB.

23. The encoder system of claim 22 wherein the rate control processor is further programmed to:
a) calculate M target bit ranges {R_{S}} for each set of MBs; and
b) utilize the M target bit ranges {R_{S}} to adjust the quantization parameters.

24. The encoder system of claim 22 wherein the rate control processor is further programmed to compute M quantization parameters for each of the M sets of MBs.

25. The encoder system of claim 22 wherein the rate control processor is further programmed to store the set of quantization parameters as an initial set of quantization parameters for a subsequent video frame to be encoded.

26. The encoder system of claim 22 wherein the rate control processor is further programmed to compare complexity measures between the M sets of MBs to adjust the set of quantization parameters.

27. The encoder system of claim 19 wherein the rate control processor is further programmed to:
a) sum the complexity measures for each MB and for each slice in the current video frame;
b) form N groups of slices according to the summed complexity measures; and,
c) order the N groups of slices into priorities according to the summed complexity measures with a highest priority group of slices having the largest summed complexity measure and a lowest priority group of slices having the smallest summed complexity.

28. The encoder system of claim 27 wherein the rate control processor is further programmed to:
a) calculate N target bit ranges {R_{G}} for each group of the N groups of slices; and,
b) utilize the N target bit ranges {R_{G}} to adjust the quantization parameters.

29. The encoder system of claim 27 wherein rate control processor is further programmed to compute M quantization parameters for each of the M sets of MBs.

30. The encoder system of claim 27 wherein the rate control processor is further programmed to store the set of quantization parameters as an initial set of quantization parameters for a subsequent video frame to be encoded.

31. The encoder system of claim 27 wherein rate control processor is further programmed to compare the summed complexity measures to adjust the set of quantization parameters.

32. The encoder system of claim 27 wherein the encoder processor is further programmed to operate on a chosen group of slices from the N group of slices in the quantization and variable length coding processes.

33. The encoder system of claim 32 wherein the rate control processor is further programmed to repeat step viii), for each group of slices from the N group of slices, starting from the highest priority group of slices and proceeding to the lowest priority group of slices.

34. The encoder system of claim 33 wherein rate control processor is further programmed to count a number of output bits in each group of slices of the N group of slices in counting the number of output bits in the compressed video frame.

35. A system for frame based constant bit rate encoding of an uncompressed video data stream into a compressed video data stream having constant bit rate R, the uncompressed video data stream composed of a sequence of frames, each frame composed of macroblocks (MBs), each MB having P pixels, wherein the system operates on frames in an input frame buffer to produce an encoded frame, the system comprised of:
a) a digital signal processor;
b) a dynamic memory for storing the uncompressed and compressed video frames;
c) a flash memory for storing program instructions;
d) a memory management unit, connected to the dynamic memory and the flash memory, for moving uncompressed video frames from an input video stream into the dynamic memory and for moving compressed video frames from the dynamic memory to an output video stream;
e) the digital signal processor programmed to:
i) initialize the input frame buffer with empty frames;
ii) load the input frame buffer with the sequence of frames;
iii) load the encoder with a first frame from the input frame buffer;
iv) obtain a number of empty frames remaining in the input frame buffer;
v) determine a target range of bits for the encoded frame;
vi) estimate a maximum number of repetitive steps (MAX_LOOP) allowed during the encoding of the first frame into the encoded frame based on the number of empty frames remaining in the input frame buffer;
vii) compare MAX_LOOP to a first threshold where if MAX_LOOP is greater than the first threshold, a low stuffing bit optimization is enabled and if MAX_LOOP is less than or equal to the first threshold, a low stuffing bit optimization is disabled;
viii) run a first rate control process to control a bit rate R of the compressed video data stream;
ix) transform the MBs of the frame into a set of spatial frequency blocks;
x) perform a combined quantization and variable length encoding (VLC) process on the set of spatial frequency blocks;
xi) set a first state to true if both the low stuffing bit optimization is enabled and if MAX_LOOP is less than a second threshold, otherwise set the first state to false;
xii) execute the following steps if the first state is true:
(1) Determine a number of stuff bits required for the encoded frame;
(2) Set a second state to true if the number of stuff bits is less than a third threshold, otherwise set the second state to false;
(3) Disable the low stuffing bit optimization if the second state is true; and
(4) Execute the following steps if the second state is false:
(a) run a second rate control process; and,
(b) perform a combined quantization and variable length coding process;
xiii) determine a number of bits in the encoded frame; and,
xiv) repeat the first rate control process if the number of bits in the encoded frame is outside the target range of bits.

36. The method of claim 35 wherein the digital signal processor is further programmed to produce a smaller number of stuffing bits in the second rate control process than the number of stuffing bits produced by the first rate control process.
